(19) United States
(12) Patent Application Publication
(10) Pub. No.: US 2026/0333333 A1
(43) Pub. Date: Oct. 22, 2026

(54) WIRELESS RELAY DEVICE AND COMMUNICATION METHOD

(71) Applicant: NTT DOCOMO, INC., Tokyo (JP)

(72) Inventors: Daisuke Kurita, Chiyoda-ku, Tokyo (JP); Hiroki Harada, Chiyoda-ku, Tokyo (JP); Weiqi Sun, Haidian District, Beijing (CN); Jing Wang, Haidian District, Beijing (CN); Lan Chen, Haidian District, Beijing (CN)

(73) Assignee: NTT DOCOMO, INC., Tokyo (JP)

(21) Appl. No.: 18/993,822

(22) PCT Filed: Jul. 21, 2022
(86) PCT No.: PCT/JP2022/028413

§ 371 Date: Jan. 13, 2025

(51) Int. Cl. H04W 72/044; H04W 16/26; H04W 72/23

(52) U.S. Cl. CPC H04W 72/046; H04W 16/26; H04W 72/23

(57) ABSTRACT

A wireless relay device includes: a communication unit configured to perform transmission and reception of signaling including control information related to a relay function to and from a base station; a control unit configured to control the relay function based on the control information; and a relay unit configured to perform the relay function of receiving an uplink signal from a terminal and transmitting the uplink signal to the base station, and of receiving a downlink signal from the base station and transmitting the downlink signal to the terminal. The control unit determines an uplink reception beam that is applied to reception of the uplink signal, an uplink transmission beam that is applied to transmission of the uplink signal, a downlink reception beam that is applied to reception of the downlink signal, and a downlink transmission beam that is applied to transmission of the downlink signal, based on the control information.

### FIELD OF THE INVENTION

The present invention relates to a wireless relay device and a communication method in a wireless communication system.

### BACKGROUND OF THE INVENTION

In 3GPP (registered trademark) (3rd Generation Partnership Project), in order to realize further larger system capacity, further faster data transmission speed, further lower latency in a wireless communication section, etc., a wireless communication method called “5G” or “NR (New Radio)” has been discussed (hereinafter, the wireless communication method is referred to as “NR”). In 6G, various wireless technologies and network architectures are being discussed to satisfy the requirement of a radio link delay of 1 ms or less while achieving throughput of 10 Gbps or more (e.g., non patent literature 1).

In the next generation communication, the high frequency band is expected to be used. From the viewpoint of the reduced number of scatterers, reduced shadowing effects, increased distance attenuation, or the like, due to the characteristics of the high frequency band, the communication quality is required to be improved. The beam control, environment, and the like, for ensuring the communication quality are expected to be required.

For example, in high frequency bands, the radio waves' strong tendency of traveling straight poses a problem by frequently causing the formation of dead zones. Accordingly, methods of improving the communication quality under the multi path environment have been discussed, the methods using a passive repeater or an active type reflector (RIS: Reconfigurable Intelligent Surface), a smart repeater that receives and amplifies a signal to be re-radiated, and the like (for example, Non-Patent Document 2).

### CITATION LIST

### Non-Patent Document

Non-Patent Document 1: 3GPP TS 38.300 V16.8.0 (2021-12)
Non-Patent Document 2: NTT DOCOMO, “White Paper 5G Evolution and 6G” (2021-02, Version 3.0), Internet<URL: https://www.nttdocomo.co.jp/binary/pdf/corporate/technology/whitepape r_6g/DOCOMO_6G_White_PaperJP_20210203.pdf>
Non-Patent Document 3: 3GPP TS 38.213 V16.8.0 (2021-12)

### SUMMARY OF THE INVENTION

### Technical Problem

Discussions are being held regarding a wireless relay device such as a reflector or a smart repeater, which relays radio waves by reflecting or passing through the radio waves from a radio wave generation source such as a base station to a radio wave reception destination such as a terminal. Here, a communication control is required to be clarified particularly for a case in which a wireless relay device that is controlled by the network relays wireless signals between the base station and the terminal.

The present invention has been made in view of the above points, and it is an object of the present invention that implements relaying of wireless signals in the wireless communication system by the wireless relay device that is controlled by the network.

### Solution to Problem

According to the disclosed technique, a wireless relay device is provided. The wireless relay device includes: a communication unit configured to perform transmission and reception of signaling including control information related to a relay function to and from a base station; a control unit configured to control the relay function based on the control information; and a relay unit configured to perform the relay function of receiving an uplink signal from a terminal and transmitting the uplink signal to the base station, and of receiving a downlink signal from the base station and transmitting the downlink signal to the terminal. The control unit determines an uplink reception beam that is applied to reception of the uplink signal, an uplink transmission beam that is applied to transmission of the uplink signal, a downlink reception beam that is applied to reception of the downlink signal, and a downlink transmission beam that is applied to transmission of the downlink signal, based on the control information.

### Advantageous Effects of Invention

According to the disclosed technique, wireless signals can be relayed by the wireless relay device in the wireless communication system.

### BRIEF DESCRIPTION OF THE DRAWINGS

FIG. 1 is a drawing for describing a wireless communication system in an embodiment of the present invention.

FIG. 2 is a drawing illustrating an example of a functional configuration of a base station 10 in an embodiment of the present invention.

FIG. 3 is a drawing illustrating an example of a functional configuration of a terminal 20 in an embodiment of the present invention.

FIG. 4 is a drawing illustrating an example of a functional configuration of a wireless relay device 30 in an embodiment of the present invention.

FIG. 5 is a drawing illustrating an operational example of a wireless relay device 30 in an embodiment of the present invention.

FIG. 6 is a drawing illustrating an example of a communication in the high frequency band.

FIG. 7 is a drawing illustrating an example of a reflection-type wireless relay device 30 in an embodiment of the present invention.

FIG. 8 is a drawing illustrating an example of a transparent-type wireless relay device 30 in an embodiment of the present invention.

FIG. 9 is a drawing illustrating an example of a network-controlled repeater in an embodiment of the present invention.

FIG. 10 is a drawing for describing an example (1) of the UL transmission beam in an embodiment of the present invention.

FIG. 11 is a drawing for describing an example (2) of the UL transmission beam in an embodiment of the present invention,

FIG. 12 is a drawing for describing an example (3) of the UL transmission beam in an embodiment of the present invention.

FIG. 13 is a drawing for describing an example (4) of the UL transmission beam in an embodiment of the present invention.

FIG. 14 is a drawing for describing an example (5) of the UL transmission beam in an embodiment of the present invention.

FIG. 15 is a drawing for describing an example (1) of beams used for an access link in an embodiment of the present invention.

FIG. 16 is a drawing for describing an example (2) of beams used for an access link in an embodiment of the present invention.

FIG. 17 is a drawing for describing an example (3) of beams used for an access link in an embodiment of the present invention.

FIG. 18 is a drawing for describing an example (4) of beams used for an access link in an embodiment of the present invention.

FIG. 19 is a drawing for describing an example (6) of beams used for an access link in an embodiment of the present invention.

FIG. 20 is a drawing for describing an example (6) of beams used for an access link in an embodiment of the present invention.

FIG. 21 is a drawing for describing an example (7) of beams used for an access link in an embodiment of the present invention.

FIG. 22 is a drawing illustrating an example of a hardware structure of the base station 10, the terminal 20, or the wireless relay device 30 in an embodiment of the present invention.

FIG. 23 is a drawing illustrating an example of a structure of a vehicle 2001 in an embodiment of the present invention.

### DETAILED DESCRIPTION OF THE PREFERRED EMBODIMENTS

In the following, while referring to the drawings, one or more embodiments of the present invention will be described. It should be noted that the embodiments described below are examples. Embodiments of the present invention are not limited to the following embodiments.

In operations of a wireless communication system according to an embodiment of the present invention, a conventional technique will be used when it is appropriate. With respect to the above, for example, the conventional techniques are related to, but not limited to, the existing LTE. Further, it is assumed that the term “LTE” used in the present specification has, unless otherwise specifically mentioned, a broad meaning including a scheme of LTE Advanced and a scheme after LTE-Advanced (e.g., NR).

Furthermore, in one or more embodiments described below, terms that are used in the existing LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above described terms are used for the sake of description convenience. Signals, functions, etc., which are similar to the above-described terms, may be referred to as different names. Further, terms, which are used in NR and correspond to the above-described terms, are NR-SS, NR-PSS, NR-SSS, NR-PBCH, NR-PRACH, etc. However, even when a signal is used for NR, there may be a case in which the signal is not referred to as “NR-”.

In addition, in an embodiment of the present invention, the duplex method may be a TDD (Time Division Duplex) method, an FDD (Frequency Division Duplex) method, or any other method (e.g., Flexible Duplex, or the like).

Further, in an embodiment of the present invention, the expression, radio (wireless) parameters are “configured (set)” may mean that a predetermined value is pre-configured, or may mean that a radio parameter indicated by a base station 10 or a terminal 20 is configured.

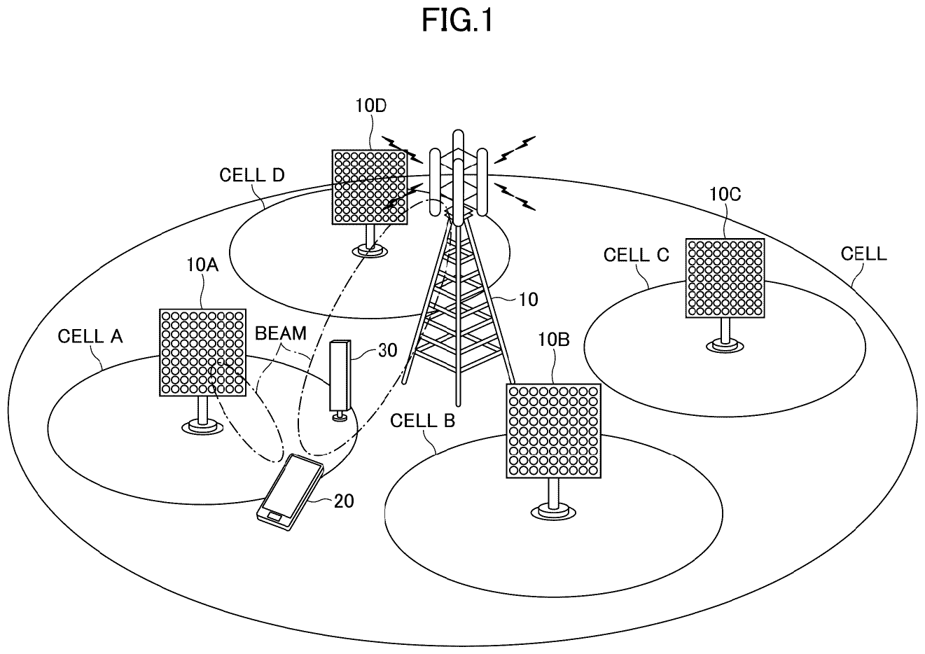

FIG. 1 is a drawing illustrating a wireless communication system according to an embodiment of the present invention. As illustrated in FIG. 1, a wireless communication system according to an embodiment of the present invention includes a base station 10 and a terminal 20. There may be a plurality of base stations 10 and a plurality of terminals 20.

The base station 10 is a communication device that provides one or more cells and performs wireless communication with the terminal 20. Physical resources of radio signals may be defined in the time domain and the frequency domain, the time domain may be defined by the number of OFDM (Orthogonal Frequency Division Multiplexing) symbols, and the frequency domain may be defined by the number of sub-carriers or resource blocks. In addition, a TTI (Transmission Time Interval) in the time domain may be a slot or a sub-slot, or the TTI may be a subframe.

The base station 10 can perform carrier aggregation to communicate with the terminal 20 by bundling a plurality of cells (multiple CCs (component carriers)). In carrier aggregation, one primary cell (PCell) and one or more secondary cells (SCells) are used.

The base station 10 transmits a synchronization signal, system information, and the like, to the terminal 20. The synchronization signal is, for example, an NR-PSS and an NR-SSS. The system information may be transmitted via a NR-PBCH or a PDSCH, for example, and may be referred to as broadcast information. As shown in FIG. 1, the base station 10 transmits a control signal or data in DL (Downlink) to the terminal 20 and receives a control signal or data in UL (Uplink) from the terminal 20. Note that, here, what is transmitted via a control channel such as PUCCH and PDCCH is called a control signal, and what is transmitted via a shared channel such as PUSCH and PDSCH is called data. These names are mere examples.

The terminal 20 may be a communication apparatus that includes a wireless communication function such as a smartphone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. Note that the terminal 20 may be referred to as a UE, and the base station 10 may be referred to as a gNB.

The terminal 20 can perform carrier aggregation to communicate with the base station 10 by bundling a plurality of cells (a plurality of CCs). In carrier aggregation, one primary cell and one or more secondary cells are used. In addition, PUCCH-SCell having PUCCH may be used.

In addition, in a wireless communication system in an embodiment of the present invention, the base station 10 is a wireless base station deployed in 5G or 6G as an example, and forms a cell. It is to be noted that the cell is a cell of a relatively large size and is referred to as a macro cell.

The base stations 10A to 10D are base stations deployed in 5G or 6G. The base stations 10A to 10D respectively form cells CA to D whose size is smaller than the macro cell. The cells A to D may be referred to as small cells, macro cells, or the like. As illustrated in FIG. 1, the cells A to D may be formed to be included in the macro cell,

The macro cell may be generally interpreted as an area with a radius of several hundred meters to tens of kilometers covered by a single base station in which communications are available. In addition, the small cell may be interpreted as a generic name of a cell that covers a smaller area compared with the macro cell.

It is to be noted that the base station 10 and the base stations OA to 10D may be described as a gNodeB (gNB), BS (Base Station), or the like. In addition, the terminal 20 may be described as a UE, MS, or the like. Furthermore, a specific configuration of a wireless communication system including the numbers and types of base stations and terminals is not limited to an example illustrated in FIG. 1.

In addition, the wireless communication system is not necessarily limited to a wireless communication system according to 5G or 6G. For example, the wireless communication system may be a wireless communication system of the next generation of 6G, or may be a wireless communication system according to LTE.

The base station 10 and the base stations 10A to 10D perform wireless communications according to 5G or 6G with the terminal 20, as an example. The base station 10, the base stations 10A to 10D, and the terminal 20 may support: a massive MIMO in which highly directional beams are generated by controlling a wireless signal transmitted from a plurality of antenna elements; a carrier aggregation (CA) in which a plurality of component carriers (CCs) are bundled to be used; a dual connectivity (DC) in which communications are simultaneously performed between the terminal 20 and each of two NG-RAN nodes; an IAB (Integrated Access and Backhaul) in which the wireless backhaul between wireless communication nodes such as gNBs is integrated with the wireless access to the terminal 20; and the like.

In addition, the wireless communication system may also support the high frequency band that is higher than the following frequency ranges (FRs) that are specified in the 3GPP release 15. For example, a band between 410 MHz to 7.125 GHZ may be supported as FR1, and a band between 24.25 GHz to 52.6 GHz may be supported as FR2. Furthermore, the wireless communication system may support a frequency band that is higher than 52.6 GHz up to 114.25 GHz. The frequency band may be referred to as a millimeter wave band.

Here, the base station 10 that supports the massive MIMO can transmit beams. In general, the massive MIMO means a MIMO communication in which an antenna with more than 100 antenna elements is used and enables a wireless communication faster than the conventional wireless communication according to the multiplexing effects of a plurality of streams. In addition, advanced beamforming is also available. The beam width can be dynamically changed in accordance with the used frequency band, the state of the terminal 20, etc. In addition, the increased reception signal power can be achieved according to the beamforming gain obtained by using narrower beams. Furthermore, good effects such as reduced interference generation, effective utilization of wireless resources are expected.

In addition, the wireless communication system may include a wireless relay device 30. In an embodiment of the present invention, as an example, the wireless relay device 30 may be a reflector (RIS), a phase control reflector, a passive repeater, an IRS (Intelligent Reflecting Surface), or the like. As a specific example, the reflector (RIS: Reconfigurable Intelligent Surface) may be what is called a meta-material reflector, a dynamic meta surface, a meta-surface lens, or the like (for example, Non-Patent Document 2).

In an embodiment of the present invention, the wireless relay device 30 relays a wireless signal transmitted from a base station 10A, for example. In the description of an embodiment of the present invention, “relay” may mean at least one of “reflect”, “pass through”, “aggregate (collect the radio waves approximately to a point)”, or “diffract”. The terminal 20 can receive a wireless signal relayed by the wireless relay device 30. In addition, the wireless relay device 30 may relay a wireless signal transmitted from the terminal 20 or may relay a wireless signal transmitted from the base station 10.

As an example, the wireless relay device 30 can change the phase of a wireless signal to be relayed to the terminal 20. From the above-described viewpoint, the wireless relay device 30 may be referred to as a phase variable reflector. It is to be noted that, in an embodiment of the present invention, the wireless relay device 30 may be, but is not limited to, a device having a function of changing the phase of a wireless signal to be relayed. In addition, the wireless relay device 30 may be referred to as a repeater, relay device, reflection array, IRS, transmission array, or the like.

In addition, in an embodiment of the present invention, the wireless relay device 30 including an RIS may be referred to as a battery less device, meta-material function device, intelligent reflecting surface, smart repeater, or the like. As an example, the wireless relay device 30 including the RIS, smart repeater, or the like, may be defined as a device having a function as described in 1) to 5) below.
1) The device may have a function of receiving a signal transmitted from the base station 10. The signal may be a DL signal such as an SSB (SS/PBCH block), PDCCH, PDSCH, DM-RS (Demodulation Reference Signal), PT-RS (Phase Tracking Reference Signal), CSI-RS (Channel State Information Reference Signal), RIS dedicated signal, or the like. The device may have a function of receiving a signal carrying information related to a meta material function. It is to be noted that the device may have a function of transmitting the signal to the terminal 20. An SSB may be a signal including a synchronization signal and broadcast information.
2) The device may have a function of transmitting a signal to the base station 10. The signal may be a UL signal such as a PRACH, PUCCH, PUSCH, DM-RS, PT-RS, SRS (Sounding Reference Signal), RIS dedicated signal, or the like, The device may have a function of transmitting information related to a meta material function. It is to be noted that the device may have a function of receiving the signal from the terminal 20.
3) The device may have a function of frame synchronization with the base station 10. It is to be noted that the device may have a function of frame synchronization with the terminal 20.
4) The device may have a function of reflecting a signal transmitted from the base station 10 or the terminal 20. For example, the reflecting function may be a function related to the phase change, or a function related to beam control (for example, a function related to control of TCI (Transmission Configuration Indication)-state, or QCL (Quasi Co Location), selection and application of beams, and selection and application of spatial filters/precoding weights).
5) The device may have a function of changing power of a signal transmitted from the base station 10 or the terminal 20. For example, the function of changing power may be power amplification.

In addition, “receive to transmit” or “relay” in the wireless relay device 30 including a RIS, smart repeater, or the like, may mean to perform transmission including the function A described below but not including the function B described below.
Function A: Applying a phase shifter.
Function B: Not including a compensation circuit (for example, amplifying and filtering).

As a different example,
Function A: Applying a phase shifter and a compensation circuit.
Function B: Not including frequency conversion.

It is to be noted that the amplitude may be amplified when the phase is changed in the wireless relay device 30 such as an RIS, or the like. In addition, “relaying” in the wireless relay device 30 such as an RIS, or the like, may mean transmitting a received signal as it is without performing a process of layer 2 or layer 3 level, may mean transmitting a received signal as it is in the physical layer level, or may mean transmitting a received signal as it is without interpreting the signal (changing the phase or amplifying the amplitude may be performed).

### (Device Configuration)

Next, examples of functional configurations of the base station 10, the terminal 20, and the wireless relay device 30 that perform processing and operations in an embodiment of the present invention will be described. The base station 10, the terminal 20, and the wireless relay device 30 include functions of performing embodiments to be described below. With respect to the above, each of the base station 10, the terminal 20, and the wireless relay device 30 may include only one function among the embodiments.

### <Base Station 10>

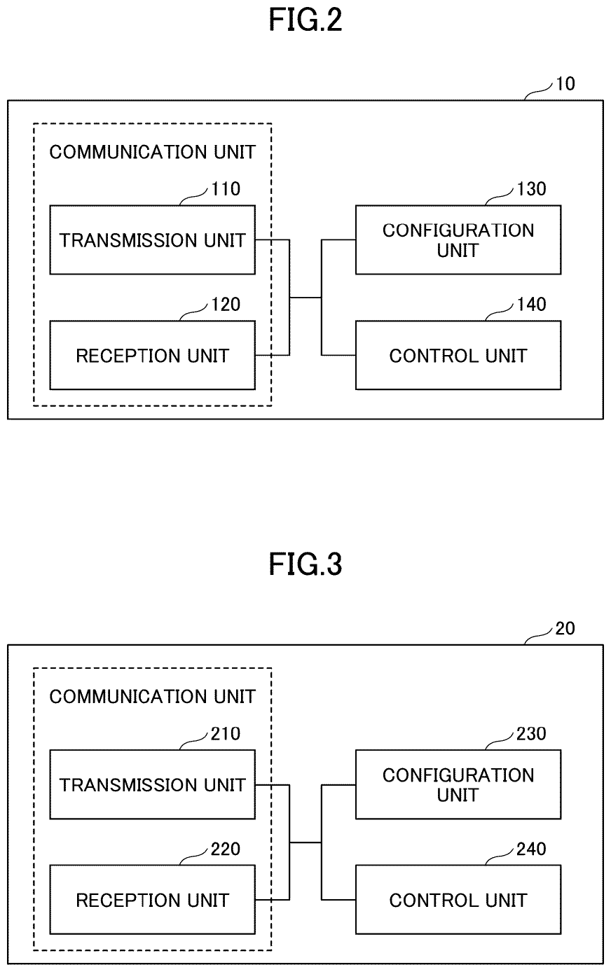

FIG. 2 is a diagram illustrating an example of a functional configuration of the base station 10. As shown in FIG. 2, the base station 10 includes a transmission unit 110, a reception unit 120, a configuration unit 130, and a control unit 140. The functional configuration illustrated in FIG. 2 is merely an example. Functional divisions and names of functional units may be anything as long as operations according to an embodiment of the present invention can be performed. The transmission unit 110 and the reception unit 120 may be referred to as a communication unit.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. Further, the transmission unit 110 has a function of transmitting NR-PSS, NR-SSS, NR-PBCH, DL/UL control signals, the DL data, and the like, to the terminal 20. In addition, the transmission unit 110 transmits configuration information, or the like, described in the embodiments.

The configuration unit 130 stores preset configuration information and various configuration information items to be transmitted to the terminal 20 in a storage apparatus and reads the preset configuration information from the storage apparatus as necessary. The control unit 140 performs, for example, resource allocation and control of the entire base station 10. Note that the functional unit related to signal transmission in the control unit 140 may be included in the transmission unit 110, and the functional unit related to signal reception in the control unit 140 may be included in the reception unit 120. Further, the transmission unit 110 and the reception unit 120 may be referred to as a transmitter and a receiver, respectively.

### <Terminal 20>

FIG. 3 is a diagram illustrating an example of a functional configuration of the terminal 20. As shown in FIG. 3, the terminal 20 includes a transmission unit 210, a reception unit 220, a configuration unit 230, and a control unit 240. The functional configuration illustrated in FIG. 3 is merely an example. Functional divisions and names of functional units may be anything as long as operations according to an embodiment of the present invention can be performed.

The transmission unit 210 and the reception unit 220 may be referred to as a communication unit.

The transmission unit 210 generates a transmission signal from transmission data and transmits the transmission signal wirelessly. The reception unit 220 receives various signals wirelessly and obtains higher layer signals from the received physical layer signals. In addition, the transmission unit 210 transmits a HARQ-ACK, and the reception unit 220 receives configuration information described in an embodiment of the present invention.

The configuration unit 230 stores, in a storage device, various configuration information items received from the base station 10 via the reception unit 220, and reads them from the storage device as necessary. In addition, the configuration unit 230 also stores pre-configured configuration information. The control unit 240 controls the entire terminal 20. Note that the functional unit related to signal transmission in the control unit 240 may be included in the transmission unit 210, and the functional unit related to signal reception in the control unit 240 may be included in the reception unit 220. Further, the transmission unit 210 and the reception unit 220 may be referred to as a transmitter and a receiver, respectively.

### <Wireless Relay Device 30>

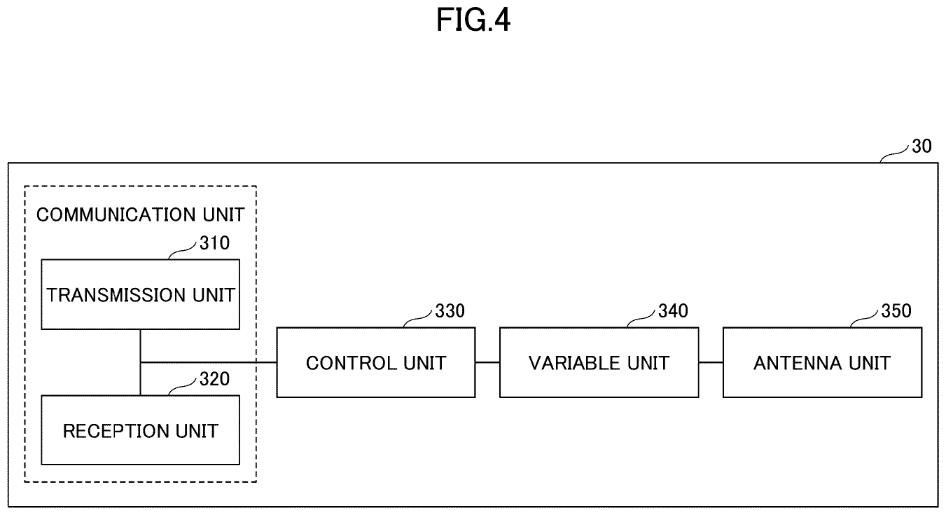

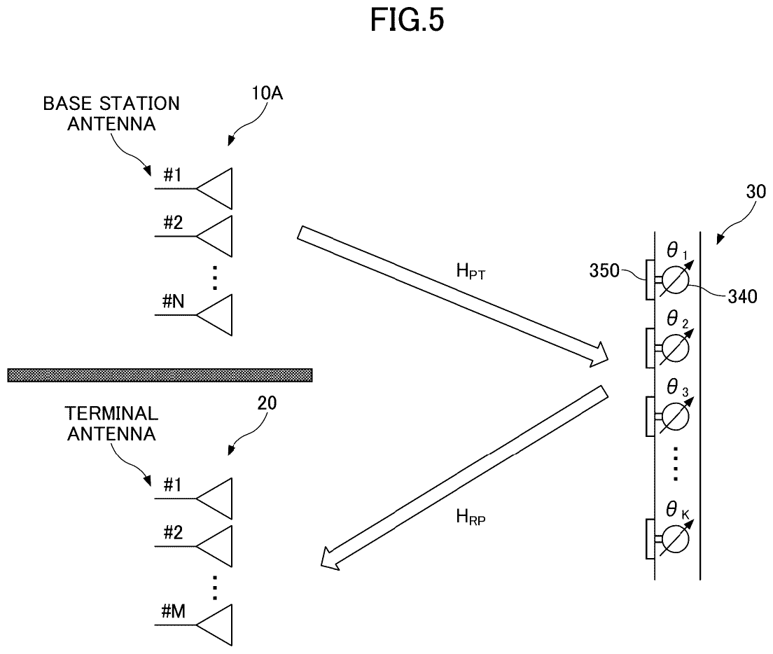

FIG. 4 is a drawing illustrating an example of a functional configuration of a wireless relay device 30 in an embodiment of the present invention. As shown in FIG. 4, the wireless relay device 30 includes a transmission unit 310, a reception unit 320, a control unit 330, a variable unit 340, and an antenna unit 350. Functional divisions and names of functional units may be anything as long as operations according to an embodiment of the present invention can be performed. The transmission unit 310 and the reception unit 320 may be referred to as a communication unit.

The antenna unit 350 includes at least one antenna that is connected to the variable unit 340. For example, the antenna unit 350 may be arranged as an array antenna. In an embodiment of the present invention, the antenna unit 350 may be specifically referred to as a relay antenna. It is to be noted that the variable unit 340 and the antenna unit 360 may be referred to as a relay unit.

The variable unit 340 is connected to the antenna unit 350, and is capable of changing the phase, load, amplitude, or the like. For example, the variable unit 340 may be a variable phase shifter, a phase shifter, an amplifier, or the like. For example, the direction of the radio waves or beams can be changed by changing the phase of the radio waves transmitted from the generation source of the radio waves to the relay antenna.

The control unit 330 is a control means for controlling the variable unit 340. In an embodiment of the present invention, the control unit 330 functions as a control unit for controlling the relaying states at the time when relaying radio waves received from the base station 10 or the terminal 20 without signal interpretation. Here, the control unit 330 may change the relaying state based on the control information received from the base station 10 or the terminal 20 via the communication unit, or may change the relaying state based on the reception state of the radio waves received from the base station 10 or the terminal 20. For example, the control unit 330 may select appropriate (directions of) reception beam and transmission beam and may control the variable unit 340, based on the control information such as an SSB, or the like. Similarly, the control unit 330 may select an appropriate combination of reception direction and transmission direction, according to the reception state, based on the criteria such as the best reception quality or the largest reception power and may control the variable unit 340.

In addition, in an embodiment of the present invention, the control unit 330 can control the variable unit 340, based on, for example, the information related to the propagation path between the terminal 20 or the base station 10A and the antenna unit 350 (hereinafter, including information estimated from the reception state and the control information). For example, the control unit 330 can relay the radio waves received from the base station 10A towards a specific direction of the recipient of the radio waves (in this case, the terminal 20) by using a known method including an active repeater, RIS, or the like, to change the phase without using the transmission power. Specifically, the control unit 330 controls the phase of the wireless signal to be relayed towards the terminal 20 or the base station 10A, based on the estimated propagation path information, HPT and HRP. In other words, according to the same principle as the beamforming, etc., the radio waves can be relayed towards a specific direction by changing the phase of the array antenna, etc. It is to be noted that the wireless relay device 30 only controls (changes) the phase of the wireless signal (radio waves) via the control unit 330, and thus, may perform the relaying without a power supply and without performing the power amplification of the wireless signal to be relayed.

In addition, the control unit 330 may obtain the information according to the reception state in an embodiment of the present invention. In addition, the reception unit 320 may obtain control information from the base station 10A or the terminal 20. For example, the reception unit 320 may receive, as the control information, various signals including SSB (including various signals described as an example in the above-described functions) transmitted from the base station 10A or the terminal 20,

In addition, the control unit 330 may estimate the propagation path information (HPT and HRP) between the generation source of the radio waves (for example, the base station 10A or the terminal 20) and the antenna unit 350, based on the reception state (for example, the change of the reception power, or the like) at the time of controlling the variable unit 340.

The propagation path information related to each propagation path (propagation channel information) is specifically information of amplitude or phase and is estimated information with respect to the propagation path of the radio waves arriving at the antenna unit 350 in an embodiment of the present invention. As an example, according to the same principle as the I/Q (In phase/Quadrature) detection, the control unit 330 may estimate the propagation path information of the antenna unit 350, based on the change of the reception power at the time when the phase of the variable unit 340 of the array-shaped antenna unit 350 is orthogonally switched.

FIG. 5 is an operation example of a wireless relay device 30 in an embodiment of the present invention. As illustrated in FIG. 5, as an example, the wireless relay device 30 is located between the base station 10A (may be another base station 10, or the like) and the terminal 20, and relays (reflects, transparently transmits, collects, diffracts) a wireless signal transmitted and received between the base station 10A and the terminal 20.

As a specific example, in a case where the wireless quality is good, the base station 10A and the terminal 20 directly transmit and receive a wireless signal without involving the wireless relay device 30. On the other hand, in a case where the wireless quality is degraded, for example, where there is an obstruction between the base station 10A and the terminal 20, the wireless relay device 30 relays a wireless signal transmitted and received between the base station 10A and the terminal 20.

Specifically, the wireless relay device 30 estimates the propagation path information, HPT and HRT, between the generation source such as the base station 10A or the terminal 20 and the relay antenna, based on the change of the reception power at the time of controlling the variable unit 340 such as a variable phase shifter. In addition, the wireless relay device 30 relays a wireless signal towards the recipient of the radio waves such as the terminal 20, by controlling the variable unit 340 such as a variable phase shifter, based on the estimated propagation path information. It is to be noted that the wireless relay device 30 may relay a wireless signal towards the recipient of the radio waves such as the base station 10A or the terminal 20 by controlling the variable unit 340 such as a variable phase shifter based on the control information received from the base station 10A or the terminal 20 without limiting the case to a case of estimating the propagation path information, HPT and HRT.

Here, the propagation path or the propagation channel is each of the communication paths of the wireless communication, and is a communication path between each of the transmission antennas and each of the reception antennas (for example, base station antennas and terminal antennas in the figure).

As an example, the wireless relay device 30 includes: an antenna unit 350 including a small multi-element antenna corresponding to the massive MIMO; and a variable unit 340 including a variable phase shifter or a phase shifter that changes the phase of a wireless signal, which is substantially the radio waves, to a specific phase, and controls the phase of the radio waves to be relayed towards the terminal 20 or the base station 10A by using the variable unit 340.

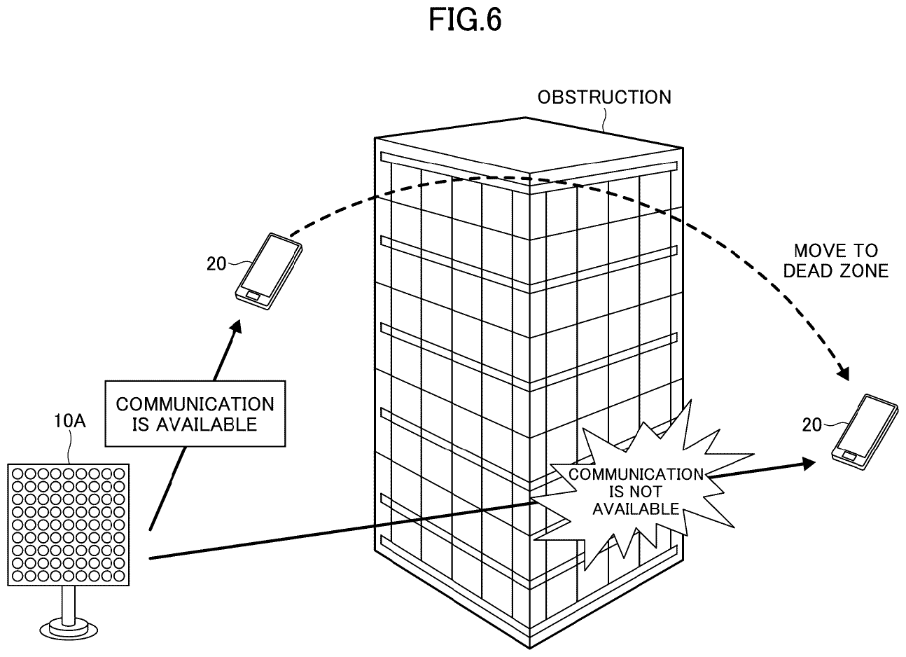

FIG. 6 is a drawing illustrating an example of a communication in the high frequency band. As illustrated in FIG. 6, in a case of using the high frequency band that is equal to or higher than several GHz to several tens of GHz, the radio waves' strong tendency of traveling straight frequently causes the formation of dead zones. If the line of sight between the base station 10A and the terminal 20 is not blocked, the wireless communication between the base station 10A and the terminal 20 is not affected even in a case where the high frequency band is used. On the other hand, for example, if the line of sight between the base station 10A and the terminal 20 is blocked by an obstruction such as a building or a tree, the wireless quality is significantly degraded. In other words, when the terminal 20 moves to a dead zone in which the line of sight is blocked by an obstruction, the communication can be interrupted.

Considering the fact that there is an application that utilizes high data rate/high capacity and low latency characteristics, it is important to resolve the dead zones to ensure the connection between the base station and the terminal without a communication interruption within the wireless communication system.

Accordingly, technologies of the radio wave propagation control device such as an RIS or smart repeater that can relay the radio waves between the base station 10A and the terminal 20 are being developed. In this way, communication characteristics can be improved by controlling the propagation characteristics of the base station signals, and thus, the coverage enhancement without using a signal source and the reduction of the installation and deployment cost due to the addition of base stations can be achieved.

Conventionally, there are a passive type and an active type in the radio wave propagation control device. While passive types have the advantage of not requiring control information, they cannot adapt to moving objects or environmental changes. On the other hand, the active type has a disadvantage of increased overhead requiring the control information, but has an advantage of being capable of variably controlling the propagation characteristics of the radio waves by changing the load (phase) state of the control antennas and capable of following the mobile body, environment change, etc.

There are two types including a feedback (FB) type and a propagation path information type in the active type radio wave propagation control device and control method. In the FB type, the variable type radio wave propagation control device searches an optimal condition by causing the terminal 20, or the like, to perform feedback of the communication state when the load (phase) state is randomly changed. On the other hand, in the propagation path information type, the optimal radio wave propagation control can be performed by determining the load state based on the propagation path information between the base station and the radio wave propagation control device. In an embodiment of the present invention, either type can be applied.

In addition, with respect to the relay method, there are types of reflection, transparent transmission, diffraction, collection, etc. In an embodiment of the present invention, as an example, configuration examples of a reflection-type and a transparent-type will be described below (refer to Non-Patent Document 2 with respect to the diffraction type and the collection type).

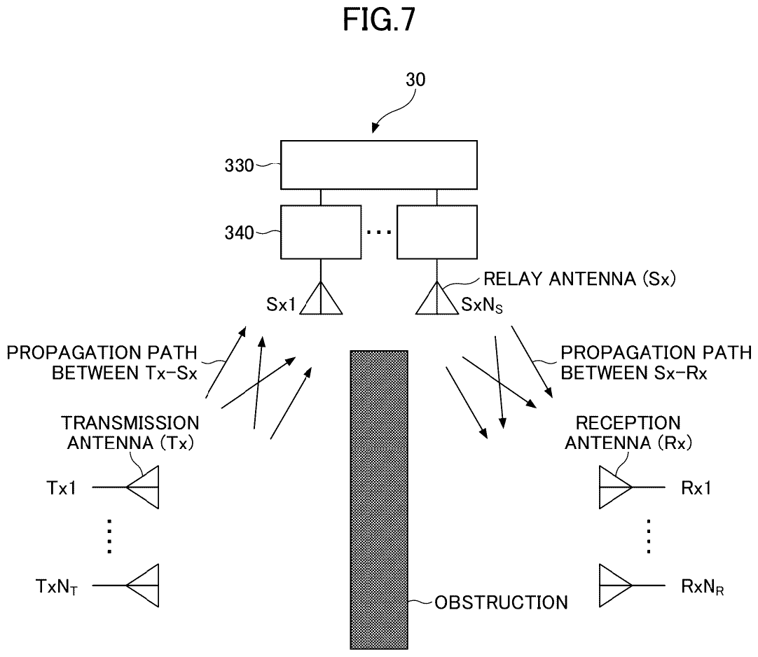

FIG. 7 is a drawing illustrating an example of a reflection type wireless relay device 30 in an embodiment of the present invention. FIG. 7 will be used for describing an example of a system structure of a reflection type wireless relay device 30. FIG. 7 is a drawing illustrating relationships among the transmission antenna Tx of the base station 10A or the like, the relay antenna Sx of the transparent-type wireless relay device 30, and the reception antenna Rx of the terminal 20 or the like. As illustrated in FIG. 7, in an embodiment of the present invention, MIMO is used as an example, there are multiple propagation paths between Tx and Sx and multiple propagation paths between Sx and Rx, and the wireless relay device 30 relays the radio waves by controlling the variable unit 340 that includes a variable phase shifter of the relay antenna Sx, or the like.

As illustrated in FIG. 7, in a case of the reflection type, the array-shaped relay antenna is arranged in a manner in which antennas face the same direction, According to the above, propagation paths of the relay antenna can be estimated based on the reception states that are observed when multiple phase conditions of the relay antenna are changed.

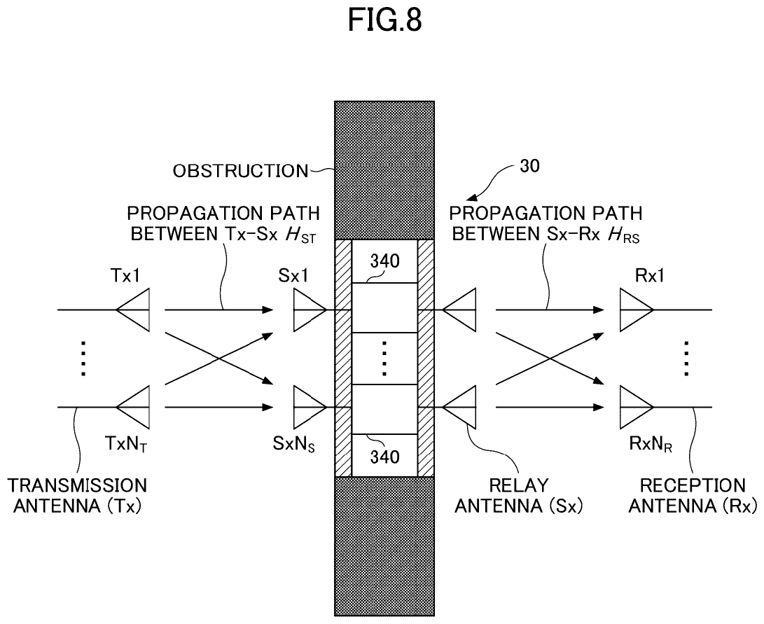

FIG. 8 is a drawing illustrating an example of a transparent-type wireless relay device 30 in an embodiment of the present invention. FIG. 8 will be used for describing an example of a system structure of a transparent-type wireless relay device 30. FIG. 8 is a drawing illustrating relationships among the transmission antenna Tx of the base station 10A or the like, the relay antenna Sx of the transparent type wireless relay device 30, and the reception antenna Rx of the terminal 20 or the like. As illustrated in FIG. 8, in an embodiment of the present invention, MIMO is used as an example, there are multiple propagation paths between Tx and Sx and multiple propagation paths between Sx and Rx, and the wireless relay device 30 relays the radio waves received from one side to the other side via the variable unit 340 of the relay antenna Sx such as a variable phase shifter as illustrated in the figure. As described above, in a case of the transparent-type, reference antennas on the left side of the figure and relay antennas on the right side of the figure are arranged as pairs respectively facing the opposite directions in a manner in which the radio waves received from one side can be relayed to the other side. Regardless of the transparent type or the reflection type, the reception state may be measured by detecting the power arrived at the relay antennas by using the power detection device, or the like. In addition, propagation paths of the relay antennas can be estimated based on the reception signals that are observed when multiple phase conditions of the relay antennas are changed.

For example, in a future network such as 6G, even higher quality is required as compared with 5G. For example, the tera bps order of ultra high speed, the optical communication level of high reliability and low latency, and the like, are required. In addition, the ultra coverage enhancement, the ultra long-distance communication, the ultra reliability communication, the virtual cell, the flexible network, the mesh network, the sidelink enhancement, the design in which RIS or smart repeater is taken into account will be required.

In order to achieve the above-described quality, the utilization of very high frequencies, for example, tera Hz waves is expected. For example, in a case of using the very high frequencies such as tera Hz waves, while there are advantages of the faster speed by utilization of ultra wide band and the lower latency by utilization of shorter symbol length, disadvantages of the narrower coverage due to the larger attenuation rate, and the reduced reliability due to the higher tendency of traveling straight are expected. Discussions are required on how to provide redundancy to each point for which 6G communications are required, that is, how to increase the number of transmission points of the communication.

As described above, the RIS reflects or transparently transmits a beam transmitted from the base station 10 or the terminal 20 in a predetermined direction to be transmitted to the terminal 20 or the base station 10. The passive type RIS is a device that does not change the control of the reflection angle, beam width, or the like, in accordance with the position of the mobile station, and thus, control information is not required but the precise beam control is difficult. The active-type RIS is a device that changes the control of the reflection angle, beam width, or the like, in accordance with the position of the mobile station, and thus, the precise beam control is available but control information is required and the overhead increases. The number of transmission points of communications can be increased by the RIS.

It is to be noted that the RIS may be referred to, but is not limited to, the names described in 1) to 5) below.
1) Battery-less device
2) Meta-material function device
3) Intelligent reflecting surface
4) Smart repeater
5) Network-controlled repeater

The RIS may be a device with a predetermined function, and the predetermined function may be at least one of 1) or 2) described below, for example.

### 1) UE Function

The reception function of a signal transmitted from the base station 10 (for example, DL signal, SSB, PDCCH, PDSCH, DM-RS, PT-RS, CSI-RS, RIS dedicated signal). According to the above-described reception function, information related to the meta-material function described in 2) below may be received. The transmission function of a signal transmitted to the base station 10 (for example, UL signal, PRACH, PUCCH, PUSCH, DM-RS, PT-RS, SRS, RIS dedicated signal). According to the above-described transmission function, information related to the meta-material function described in 2) below may be transmitted. The frame synchronization function with the base station 10.

### 2) Meta Material Function

The reflecting function of a signal transmitted from the base station 10 or the terminal 20 (for example, phase change). The signal reflection may be performed by performing phase change by each of a plurality of reflecting elements included in the RIS, or the signal reflection may be performed by performing the common phase change by the plurality of reflecting elements. The function related to beam control (for example, a function related to control of TCI-state or QCL, application of beam selection, application of spatial filter/precoding weight selection). The power change function of a signal transmitted from the base station 10 or the terminal 20 (for example, power amplification). Each of the reflecting elements included in the RIS may perform different power change, or the plurality of reflecting elements may perform common power change.

“Receive to transmit” by the RIS may mean to reflect radio waves/signal. Hereinafter, the terms of “base station” and “terminal” will be used. However, the terms are not limited to “base station” and “terminal”, and may be replaced with a communication device. The RIS may be replaced with a smart repeater, a relay device, or the like.

For example, the RIS may operate by assuming 1) to 6) described below.
1) The network operator configures the RIS
2) The RIS is fixed and does not move
3) The RIS relays a signal from a single base station alone
4) The RIS is capable of receiving and transmitting a control signal
5) The RIS operates by using the half duplex communication
6) Single RIS environment

Here, discussions are being held regarding the network-controlled repeater that is a wireless relay device controlled by the network. The network-controlled repeater is different from the conventional repeater that performs amplification and transfer. For example, beams, timings, DL or UL, ON or OFF, and transmission power can be controlled by the network. Hereinafter, “network-controlled repeater” may be also referred to as “repeater”.

The network-controlled repeater is used as an in-band RF repeater in order to enhance coverage in the FR1 and FR2 bands. In particular, the network-controlled repeater is expected to be used for the FR2 deployment in the outdoor and O21 (outdoor to indoor) scenario. For example, an environment of a single hop and no move may be assumed to be an environment for the network-controlled repeater. In addition, the network-controlled repeater may be transparent for UEs. In addition, the network controlled repeater may be capable of simultaneously maintaining the link between the gNB and the repeater and the link between the repeater and the UE.

With respect to the side control information used for controlling the network-controlled repeater from the network, the following items are being discussed.
Information related to the beamforming
Information related to the timing of transmission or reception
Information related to UL-DL TDD configuration
ON-OFF information for interference control and energy saving
Power control for interference control

In addition, the side control information via L1 and L2 signaling is being discussed. In addition, the identification and authentication of the network-controlled repeater is being discussed.

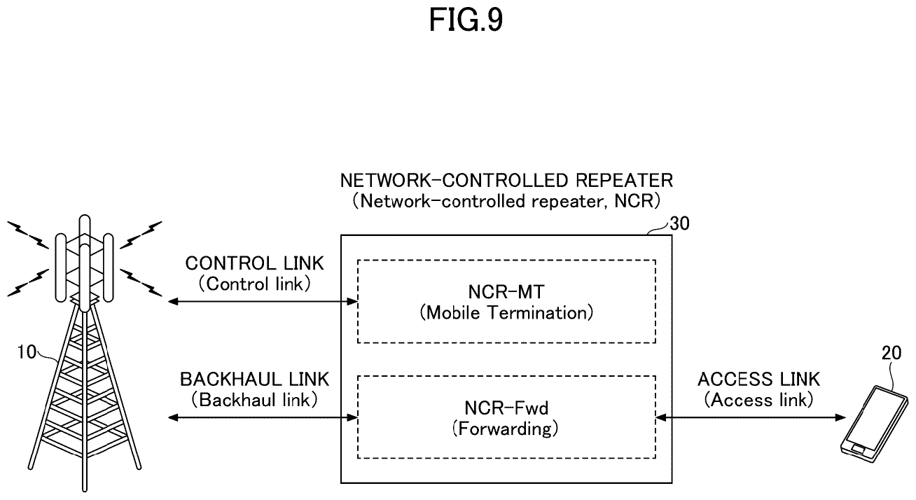

FIG. 9 is a drawing illustrating an example of a network-controlled repeater in an embodiment of the present invention. The network controlled repeater (NCR) may be configured as illustrated in FIG. 9. Hereinafter, the network-controlled repeater may be also referred to as an NCR. The NCR-MT (Mobile Termination) may be defined as a device that has a function of communicating with a base station 10 via a control link (C-link). For example, transmission and reception of the side control information can be performed via a control link. The control link may be based on the NR-Uu interface.

The NCR-Fwd (Forwarding) may be defined as a device that has a function of performing amplification and transfer of UL and DL RF signals between the base station 10 and the terminal 20 via a backhaul link and an access link. An operation of the NCR-Fwd may be controlled based on the side control information received from the base station 10. As illustrated in FIG. 9, the backhaul link corresponds to communications between the base station 10 and the NCR-Fwd and the access link corresponds to communications between the terminal 20 and the NCR-Fwd.

In FR2, information related to beams is beneficial. For example, the information related to beams may be recommended as the side control information for controlling an operation of the NCR 30 in at least an access link. For example, a beam that is applied to the access link may be indicated by a beam index, or may be indicated by a source RS index (for example, an indicator such as TCI).

The same TCI state as that for the beam used by the NCR-MT for the control link may be assumed for the beam used by the NCR-Fwd for the backhaul link.

Hereinafter, an outline of an embodiment of the present invention will be described.

### 1) Configuration Method of NCR-Fwd Access Link UL Reception Beams

Series of a plurality of gNB transmission beam IDs may be indicated
One gNB transmission beam ID may be indicated and the same beam ID may be configured in series
Series of a plurality of gNB transmission beam IDs may be periodically configured
One gNB transmission beam ID may be indicated and the same beam ID may be periodically configured in series.
DCI 0_x TCI state may be referred to (the repeater is required to decode the DCI for the UE)
CG-PUSCH configuration/activation TCI state may be used or may be specified for the repeater
TCI state of 3GPP release 17 may be used

### 2) Configuration Method of NCR-Fwd Access Link Beams

NCR-Fwd access link candidate beams may be configured and the beam that is to be finally used may be configured from among the candidate beams
NCR-Fwd access link candidate beams may be configured first, and then some of the candidate beams may be further configured
Candidate beams may be reported by the NCR and the beam that is to be used may be configured from among the reported candidate beams
Candidate beams may be reported by the NCR and some of the candidate beams may be configured from among the reported candidate beams
Candidate beams may be reported by the NCR, candidate beams may be configured first from among the reported candidate beams, and then, some of the candidate beams may be further configured

### 3) Details of the Configuration Method of NCR Fwd Access Link Beams

Candidate beams of the above-described 2)
   Alt. 1: Common for DL/UL
   Alt. 2: Different for each DL/UL
Beam indexes reported by the NCR in the above-described 2)
   Alt. 1: Common for DL/UL
   Alt. 2: Different for each DL/UL
A set of candidate beams and a subset of the candidate beams in the above-described 2)
   Alt. 1: A set of candidate beams and a subset of the candidate beams are both common for DL/UL
   Alt. 2: A set of candidate beams is common for DL/UL, and subsets of the candidate beams are different for each DL/UL
   Alt. 3: Sets of candidate beams and subsets of the candidate beams are both different for each DL/UL

### 4-1) the NCR-Fwd Backhaul DL Reception Beams May be Determined by One of the Following Methods

### 4-2) the NCR-Fwd Backhaul UL Transmission Beams May be Determined by One of the Following Methods

In a case of time resources for which the NCR-MT and the NCR-Fwd operate at the same time, beams are determined by following the NCR-MT
In a case of time resources for which the NCR-MT and the NCR-Fwd do not operate at the same time, a method of determining the beams of the NCR_Fwd is specified
   5) In a case where the Rel-17 unified TCI framework is used, in the same manner as in the above described 4-1/4-2, beams are determined by following the TCI state of the NCR-MT if the resources are for simultaneous operations and a method of determining the beams is specified if the resources are for non-simultaneous operations.

Here, how to control NCR-Fwd UL reception beams has been unclear.

Accordingly, the UL reception beams transmitted by the NCR 30 may be configured as described below,

### <Operation 1>

The NCR 30 may expect that the method of configuring UL reception beams for each time unit is to be at least one of the following options.

### <Option 1>

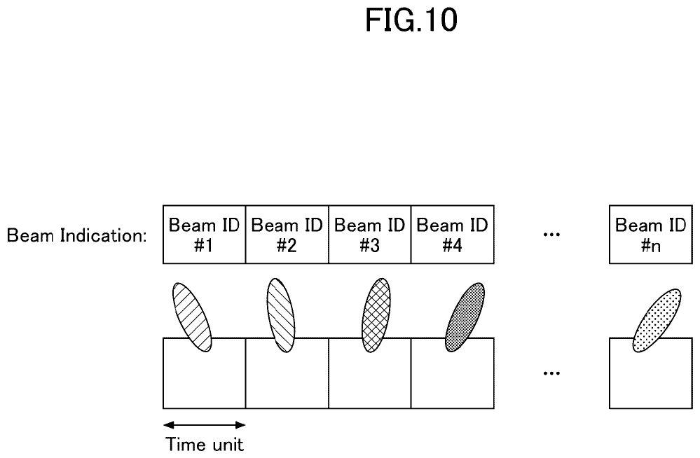

FIG. 10 is a drawing for describing an example (1) of the UL reception beams in an embodiment of the present invention.

The NCR 30 may expect that a sequence of UL reception beam IDs is to be specified to be applied to a sequence of time units. Each beam ID is applied to the corresponding time unit.

The NCR 30 may expect that a sequence of time units is to be indicated as the number of a series of time units by indicating the starting time unit and the time unit length.

It is to be noted that the starting time and the time length may be defined in advance. For example, the NCR 30 may expect that the start is to be a predefined offset or a predefined time unit length from reception of the beam indication. In addition, the NCR 30 may expect that the sequence of time units is to be indicated as a sequence of time unit IDs.

### <Option 2>

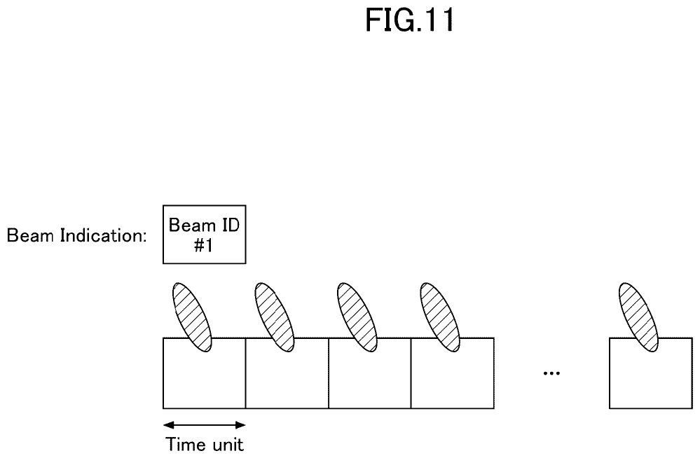

FIG. 11 is a drawing for describing an example (2) of the UL reception beams in an embodiment of the present invention.

The NCR 30 may expect that one UL reception beam ID is to be indicated and is to be applied to a series of time units. The NCR 30 may expect that a sequence of time units is to be indicated as the number of a series of time units by indicating the starting time unit and the time unit length.

It is to be noted that the starting time and the time length may be defined in advance. For example, the NCR 30 may expect that the beam is to be applied from a predefined offset or a predefined time unit length from reception of the beam indication, or is to be applied until the new beam indication. In addition, the NCR 30 may expect that the sequence of time units is to be indicated as a sequence of time unit IDs.

### <Option 3>

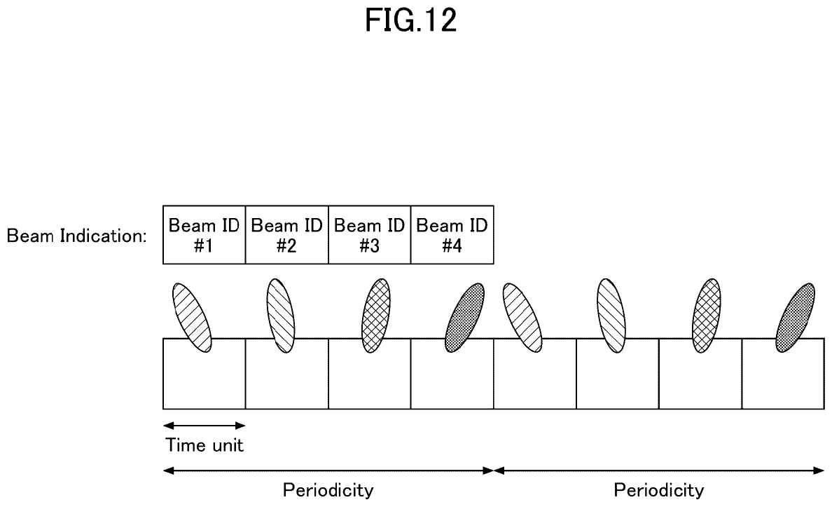

FIG. 12 is a drawing for describing an example (3) of the UL reception beams in an embodiment of the present invention.

The NCR 30 may expect that a periodic pattern is to be indicated. The NCR 30 may expect that a periodicity and an offset are to be indicated. In addition, the NCR 30 may expect that a sequence of UL reception beam IDs is to be indicated by corresponding beam IDs that are applied to each periodic time unit.

### <Option 4>

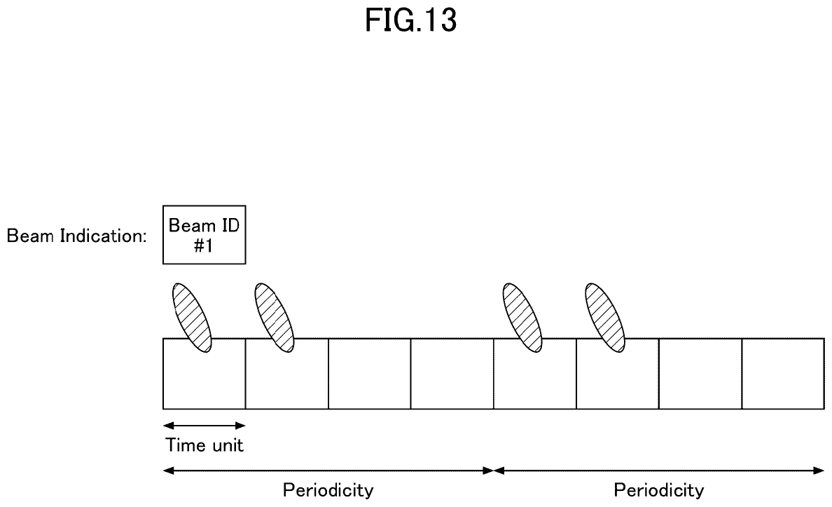

FIG. 13 is a drawing for describing an example (4) of the UL reception beams in an embodiment of the present invention.

The NCR 30 may expect that a periodic pattern is to be indicated. The NCR 30 may expect that a periodicity and an offset are to be indicated. In addition, the NCR 30 may expect that one UL reception beam ID is to be indicated and the indicated beam ID is to be applied to a periodic series of time units.

The NCR 30 may expect that a sequence of time units is to be indicated as the number of a series of time units by indicating the starting time unit and the time unit length.

In addition, the NCR 30 may expect that the starting time and the time length are to be predefined. For example, the NCR 30 may start application of the UL reception beam from a predefined offset or a predefined time unit length from reception of the beam indication. In addition, the NCR 30 may expect that the sequence of time units is to be indicated as a sequence of time unit IDs.

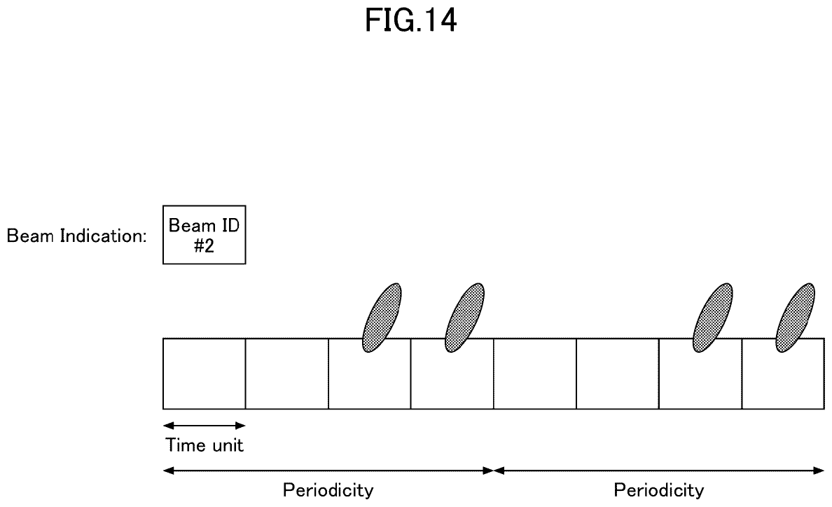

FIG. 14 is a drawing for describing an example (5) of the UL reception beams in an embodiment of the present invention. In a case where there are time units for which beams are not indicated as illustrated in FIG. 13, the NCR 30 may expect that the beams are to be indicated, for example, as illustrated in FIG. 14 separately from the beam indication as illustrated in FIG. 13.

### <Option 5>

The NCR 30 may expect that the PUSCH scheduling DCI is to be reused (DCI format 0_X). The SRI field or a new field of the PUSCH scheduling DCI (DCI format 0_X) may be a field indicating a UL reception beam ID.

The NCR 30 may expect that the indicated UL reception beam ID and the corresponding UL reception beam are to be applied to a slot/symbol that is indicated by the time domain resource allocation field of the PUSCH scheduling DCI (DCI format 0_X).

In addition, considering the fact that there is a case in which PUSCH is not required to be transmitted, the NCR 30 may only need to amplify-and-forward a UL signal transmitted from the base station 10. In a case of receiving PUSCH scheduling DCI (DCI format 0_X), the base station 10 may indicate that the NCR 30 only needs to forward a UL signal from the terminal 20. The base station 10 and the NCR 30 may expect that PUSCH is to be not transmitted using a resource indicated by DCI according to the following methods.

The NCR 30 may forward only a UL signal from the terminal 20 to the base station 10 by using a slot/symbol indicated by DCI in a case where one or more conventional fields (or a new field) of DCI are configured to be a predefined value. That is, the NCR 30 is not required to transmit PUSCH via a resource indicated by DCI.

In addition, the NCR 30 may forward only a UL signal from the terminal 20 to the base station 10 using a slot/symbol indicated by DCI and the NCR 30 is not required to transmit PUSCH using the resource indicated by DCI to the NCR 30 in a case where the DCI is detected with a specific RNTI/SS set/CORESET.

It is to be noted that a new DCI format may be introduced. The new DCI format includes a field that is similar to the SRI field of the PUSCH scheduling DCI (DCI 0_X) indicating the UL reception beam ID, for example.

The new DCI format includes a field that is similar to the time domain allocation field of the PUSCH scheduling DCI (DCI 0_X), for example. This field indicates a time (a slot offset or a symbol position in a slot) to which the specified UL reception beam ID can be applied.

### <Option 6>

The NCR 30 may expect that the CG (Configured Grant) configuration/activation is to be reused.

The SRI field, a new field of the CG configuration (RRC), or the CG activation DCI indicates a UL reception beam ID. The NCR 30 may expect that the indicated UL reception beam ID and the corresponding UL reception beam are to be applied to the slot/symbol indicated by the CG configuration (RRC) and the CG activation DCI.

In addition, considering the fact that there is a case in which the NCR 30 is not required to transmit PUSCH, the NCR 30 only needs to amplify-and-forward a UL signal from the terminal 20 to the base station 10 in a case of one or more conventional fields (or new fields) when receiving the CG configuration/activation. The NCR 30 may forward only a UL signal from the terminal 20 to the base station 10 by using the slot/symbol that is configured by the CG configuration (RRC) and the CG activation DCI and is not required to transmit PUSCH by using the resource in a case where the CG configuration or the CG activation DCI is configured to be a predefined value.

In addition, the NCR 30 may expect that a new RRC configuration and activation DCI that are similar to the CG configuration/activation are to be introduced. The new RRC configuration or DCI may include a field indicating a UL reception beam ID.

The new RRC configuration or DCI may include a field indicating a time (a periodicity, a slot offset, a symbol position in a slot) to which the specified UL reception beam ID can be applied.

### <Option 7>

The NCR 30 may expect that the 3GPP release 17 unified TCI state indication DCI is to be reused. The TCI state field or a new field in the 3GPP release 17 unified TCI state indication DCI may indicate a UL reception beam ID.

The NCR 30 may expect that the indicated UL reception beam ID and the corresponding UL reception beam are to be applied starting from the first symbol/slot that is at least X slots/symbols after the last slot/symbol of the PUCCH carrying HARQ ACK for the DCI.

In addition, the NCR 30 may start the application from the first symbol/slot that is at least X slots/symbols after the DCI receiving slot/symbol.

X can be predefined, configured, or subject to the capability information. In addition, the NCR 30 may expect that a new DCI format is to be introduced. The new DCI format may include, for example, a field that is similar to the TCI state field in the release 17 unified TCI state indication DCI, which indicates the UL reception beam ID. In this case, the application time of the beam indication may be the same as described above.

In the above-described options, the time unit may be a slot, a symbol, a slot group, a symbol group, a sub-slot, or the like.

A plurality of the above-described options may be supported. The NCR 30 may expect that one or more options are to be applied. The NCR 30 may expect that the supported one or more options are to be reported as the capability information of the NCR 30. Each option may be expected to be defined as a mandatory or optional function.

In the above-described options, a plurality of UL reception beam IDs may be indicated for a time unit. In addition, in the above-described options, a plurality of UL reception beam IDs may be indicated for a plurality of frequency domain resource units for a time unit.

According to the above-described operation, the configuration of UL reception beams in the access link can be performed appropriately by the NCR 30.

The UL reception beam is used for receiving a signal from the UE 20 by referring to a beam that is used by the NCR-Fwd for the access link. The UL reception beam that is used by the NCR-Fwd may be indicated by using, for example, the methods described in the following 1) to 4).

### 1) Beam Index

The beam index may directly refer to the spatial domain filter of the NCR-Fwd that is used for UL reception in the access link. Different beam indexes may refer to different spatial domain filters.

### 2) Source RS Index

The source RS for NCR Fwd UL reception may be defined as a new resource type. Each source RS for NCR-Fwd UL reception may be arranged in time resources indicated by the base station 10. In each source RS for NCR-Fwd UL reception, the NCR 30 amplifies-and-forwards a UL signal between the terminal 20 and the base station 10.

In other words, when a source RS for NCR-Fwd UL reception is indicated for a time unit, the NCR-Fwd may apply or use the same spatial domain filter for its UL reception in the access link at the time unit and for its UL reception in the indicated source RS for NCR-Fwd UL reception. The definition of the source RS for NCR-Fwd UL reception will be described in detail below.

### 3) TCI-Like Indicator

The NCR-Fwd TCI state may be associated with the source RS for NCR-Fwd UL reception of the above-described 2). In a case where an index indicating the NCR-Fwd TCI state is indicated for a time unit, the NCR-Fwd may apply or use the same spatial domain filter to the UL reception in the access link in the time unit and to the UL reception in the source RS for the NCR-Fwd UL reception associated with the indicated NCR-Fwd TCI state.

4) Beam Index of the Base Station 10 (for Example, CSI-RS or SSB Index, or TCI State Index Associated with the CSI-RS or SSB of the Base Station 10)

The NCR-Fwd UL reception beam or spatial domain filter may be associated with the beam of the base station 10. In a case where a beam index of the base station 10 is indicated for a time unit, the NCR-Fwd may apply or use the beam or the spatial domain filter associated with the beam of the base station 10 to the UL reception in the access link in the time unit.

Hereinafter, an example will be described in which the source RS of the NCR-Fwd UL reception of the NCR 30 is specified.

The “source RS of the NCR-Fwd UL reception” may be a type of resource that is newly defined to be used for beam management of the NCR 30. Each “source RS for the NCR-Fwd UL reception” is a set of time and frequency resources.

The NCR 30 may amplify UL signals to be forwarded from the terminal 20 to the base station 10 by using each “source RS for the NCR-Fwd UL reception”. Each “source RS for the NCR-Fwd UL reception” may occupy many adjacent symbols.

The supported candidate numbers of the adjacent symbols may be pre-defined, and may be, for example, selected from {1, 2, 4, 8, 10, 12, 14}.

The NCR 30 may expect that a plurality of “source RSs for the NCR-Fwd UL reception” are to be configured. The supported maximum number of resources may be pre-defined, or may be subject to the capability information of the NCR 30.

The NCR 30 may expect that a source RS for the NCR-Fwd UL reception is to be configured. Each resource set may include a plurality of source RSs for the NCR-Fwd UL reception. The supported maximum number of resource sets may be pre-defined, or may be subject to the capability information of the NCR 30.

The maximum number of resources that are supported by one resource set may be pre-defined or may be subject to the capability information of the NCR 30.

The NCR 30 may expect that the following parameters are to be configured for each source RS for the NCR-Fwd UL reception that is configured by the side control information (RRC/MAC-CE/DCI).
Resource Id/resource set ID
Time domain types, that is, the resource type={periodic, semi-persistent, aperiodic} of the resource/resource set
Resource/resource set periodicity (in a case of P/SP resource/resource set)
Slot level offset of the resource/resource set
Symbol positions of the resources in a slot (including a starting symbol and the number of symbols)
Uplink transmission beam in each resource

The NCR 30 may expect that activation/deactivation is to be performed by the side control information (RRC/MAC-CE/DCI) in a case of semi-persistent resources/resource set. In a case where the uplink transmission beam indicated by the resource is activated, the NCR 30 may forward the UL signal from the terminal 20 to the base station 10 by using it. In a case where it is deactivated, forwarding is not required to be performed.

A resource set ID/resource ID and an indication of activation/deactivation may be expected to be included in the side control information.

In a case of aperiodic resources/resource set, the NCR 30 may expect that the resources/resource set is to be triggered by the side control information (RRC/MAC-CE/DCI). In addition, in a case where the trigger is performed, the NCR 30 may forward the UL signal from the terminal 20 to the base station 10 by using the uplink transmission beam indicated by the resource.

The NCR 30 may expect that the resource ID/resource set ID is to be included in the side control information. Alternatively, the NCR 30 may expect that the trigger state is to be included in the side control information. The NCR 30 may expect that the trigger state is to be configured for each resource/resource set.

The NCR 30 may expect that a slot offset and symbol positions of the resources in a slot (including the starting symbol and the number of symbols) are to be indicated by the trigger-side control information.

According to the above-described Operation 1, the UL reception beam can be controlled based on the source RS for the NCR-Fwd UL reception of the NCR 30.

The NCR capabilities described in 1) and 2) below may be defined.
1) Whether or not the NCR-Fwd UL reception beam controlled by the network is supported
2) Supported number of NCR-Fwd UL reception beams

The above described Operation 1 may be applied only in a case where the above-described capability is supported by the NCR 30 and the feature is activated by the base station 10.

### <Operation 2>

As described above, the beam of the NCR-Fwd in the access link may be indicated by a beam index or an index of the source RS. How to configure the beam candidate sets of the NCR-Fwd in the access link is required to be determined.

For example, the beam of the NCR-Fwd in the access link from among the beam candidate sets may be indicated. For example, the candidate sets of the NCR-Fwd DL transmission beam in the access link may be the same as, or may be separated from, the candidate sets of the NCR-Fwd UL reception beam in the access link.

The NCR-Fwd DL transmission beams in the access link and the NCR-Fwd UL reception beams in the access link may be handled as described in the following A) to E).
A) The set of candidate beams may be indicated via RRC signaling (hereinafter, RRC signaling is also referred to as RRC), MAC-CE, and/or DCI. The NCR-Fwd DL transmission beams in the access link or the NCR-Fwd UL reception beams in the access link from among the above-described indicated candidate beams may be indicated via RRC, MAC-CE, and/or DCI.
B) The set of candidate beams may be indicated by RRC and MAC-CE, may be indicated by MAC-CE and DCI, may be indicated by RRC and DCI, or may be indicated by RRC, MAC-CE, and DCI.

In a case of an indication via RRC and MAC-CE, a set of candidate beams may be indicated via RRC. A subset of the candidate beams from among the set of candidate beams indicated via RRC may be indicated via MAC-CE. The NCR-Fwd DL transmission beam in the access link or the NCR-Fwd UL reception beam in the access link from among the subset of the candidate beams indicated via MAC-CE may be indicated via MAC-CE, for example. In addition, the NCR 30 may determine the NCR-Fwd DL transmission beam in the access link or the NCR-Fwd UL reception beam in the access link from among the subset of the candidate beams indicated via MAC-CE.

In a case of an indication via MAC-CE and DCI, a set of candidate beams may be indicated via MAC-CE. A subset of the candidate beams from among the set of candidate beams indicated via MAC-CE may be indicated via DCI. The NCR-Fwd DL transmission beam in the access link or the NCR-Fwd UL reception beam in the access link from among the subset of the candidate beams indicated via DCI may be indicated via DCI, for example. In addition, the NCR 30 may determine the NCR-Fwd DL transmission beam in the access link or the NCR-Fwd UL reception beam in the access link from among the subset of the candidate beams indicated via DCI.

In a case of an indication via RRC and DCI, a set of candidate beams may be indicated via RRC. A subset of the candidate beams from among the set of candidate beams indicated via RRC may be indicated via DCI. The NCR-Fwd DL transmission beam in the access link or the NCR-Fwd UL reception beam in the access link from among the subset of the candidate beams indicated via DCI may be indicated via DCI, for example. In addition, the NCR 30 may determine the NCR-Fwd DL transmission beam in the access link or the NCR-Fwd UL reception beam in the access link from among the subset of the candidate beams indicated via DCI.

In a case of an indication via RRC, MAC-CE, and DCI, a set of candidate beams may be indicated via RRC. A subset of the candidate beams from among the set of candidate beams indicated via RRC may be indicated via MAC-CE. A sub-subset of the candidate beams from among the subset of candidate beams indicated via MAC-CE may be indicated via DCI. The NCR-Fwd DL transmission beam in the access link or the NCR-Fwd UL reception beam in the access link from among the sub-subset of the candidate beams indicated via DCI may be indicated via DCI, for example. In addition, the NCR 30 may determine the NCR-Fwd DL transmission beam in the access link or the NCR Fwd UL reception beam in the access link from among the subset of the candidate beams indicated via DCI.
C) The set of candidate beams may be reported from the NCR 30 to the base station 10. The NCR-Fwd DL transmission beam in the access link or the NCR-Fwd UL reception beam in the access link may be indicated from among the set of candidate beams reported by the NCR 30.
D) The set of candidate beams may be reported from the NCR 30 to the base station 10. A subset of the candidate beams from among the set of candidate beams reported by the NCR 30 may be indicated via RRC, MAC-CE, or DCI. The NCR-Fwd DL transmission beam in the access link or the NCR-Fwd UL reception beam in the access link from among the subset of the candidate beams indicated via RRC, MAC-CE, or DCI may be indicated.
E) The set of candidate beams may be reported from the NCR 30 to the base station 10. A subset of the candidate beams from among the set of candidate beams reported by the NCR 30 may be indicated via RRC and MAC-CE, may be indicated via MAC-CE and DCI, may be indicated via RRC and DCI, or may be indicated via RRC, MAC-CE, and DCI. The NCR-Fwd DL transmission beam in the access link or the NCR-Fwd UL reception beam in the access link from among the subset of the candidate beams indicated via RRC, MAC-CE, or DCI may be indicated.

In the above-described A) to E), the maximum number of candidate beams configured by RRC, the maximum number of candidate beams activated by MAC-CE, or the maximum number of candidate beams reported by the NCR 30 may be pre-defined or may be determined depending on the capability of the NCR 30. The maximum number of the NCR-Fwd DL transmission beams in the access link may be different from the maximum number of NCR-Fwd UL reception beams in the access link.

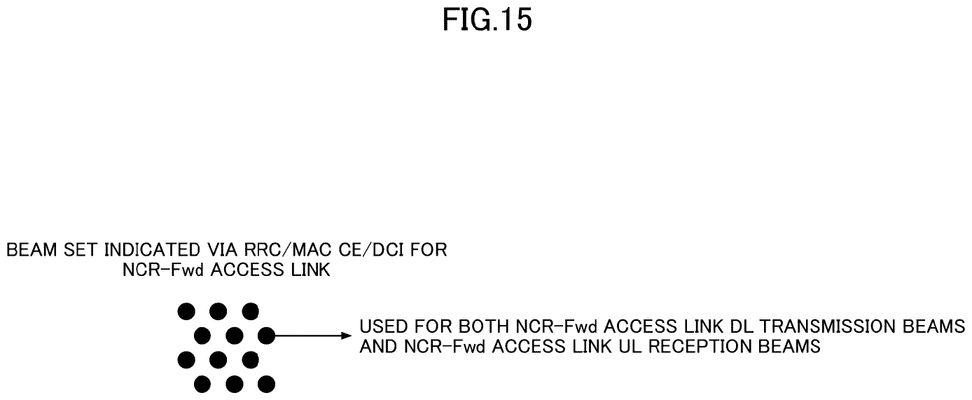

FIG. 15 is a drawing for describing an example (1) of beams used for an access link in an embodiment of the present invention. As illustrated in FIG. 15, the set of candidate beams may be indicated, to the NCR 30, in common for the NCR-Fwd access link DL transmission beam and for the NCR-Fwd access link UL reception beam via RRC, MAC-CE, and/or DCI. One of the set of candidate beams may be used for both the NCR-Fwd access link DL transmission beam and the NCR-Fwd access link UL reception beam. It is to be noted that an operation illustrated in FIG. 15 may applied to the above-described A) and the above-described D).

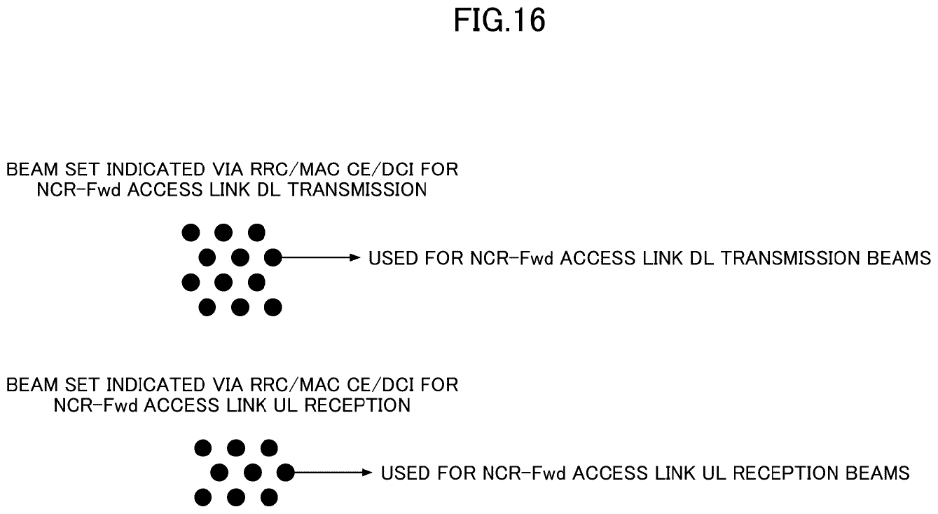

FIG. 16 is a drawing for describing an example (2) of beams used for an access link in an embodiment of the present invention. As illustrated in FIG. 16, the set of candidate beams for the NCR-Fwd access link DL transmission beam and the set of candidate beams for the NCR-Fwd access link UL reception beam may be separately indicated to the NCR 30 via RRC, MAC-CE, and/or DCI. One of the set of candidate beams for the NCR-Fwd access link DL transmission beam may be used for the NCR-Fwd access link DL transmission beam. One of the set of candidate beams for the NCR-Fwd access link UL reception beam may be used for the NCR-Fwd access link UL reception beam. It is to be noted that an operation illustrated in FIG. 16 may applied to the above-described A) and the above-described D).

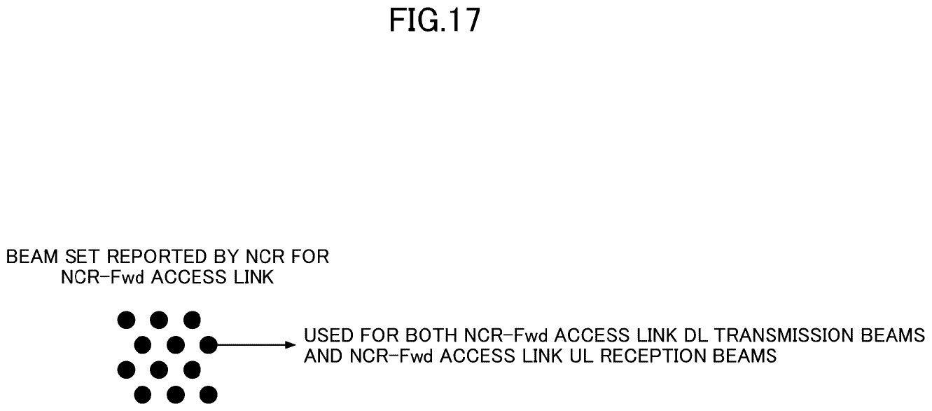

FIG. 17 is a drawing for describing an example (3) of beams used for an access link in an embodiment of the present invention. As illustrated in FIG. 17, the set of candidate beams reported by the NCR 30 may be indicated to the NCR 30 in common for the NCR-Fwd access link DL transmission beam and for the NCR-Fwd access link UL reception beam via RRC, MAC-CE, and/or DCI. One of the set of candidate beams may be used for both the NCR-Fwd access link DL transmission beam and the NCR Fwd access link UL reception beam. It is to be noted that an operation illustrated in FIG. 17 may applied to the above-described C), the above-described D), and the above-described E).

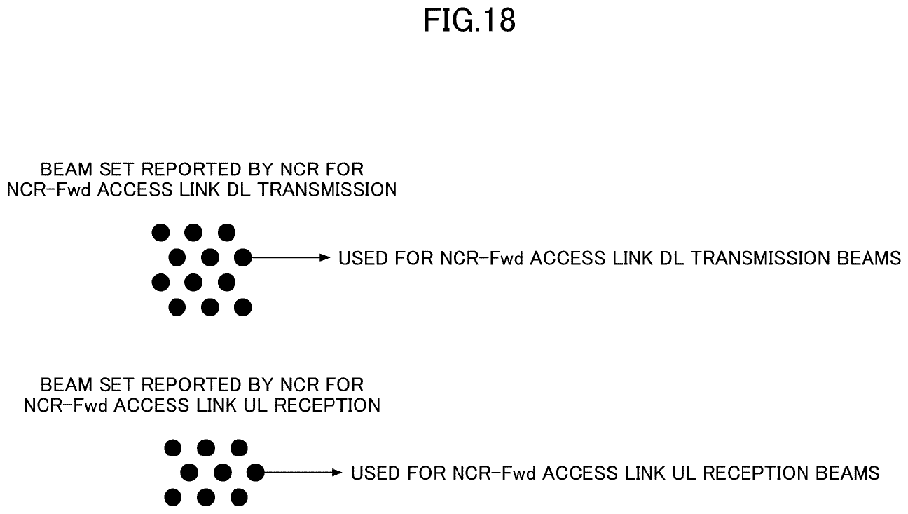

FIG. 18 is a drawing for describing an example (4) of beams used for an access link in an embodiment of the present invention. As illustrated in FIG. 18, the set of candidate beams for the NCR-Fwd access link DL transmission beam reported by the NCR 30 and the set of candidate beams for the NCR-Fwd access link UL reception beam reported by the NCR 30 may be separately indicated to the NCR 30 via RRC, MAC-CE, and/or DCI. One of the set of candidate beams for the NCR-Fwd access link DL transmission beam may be used for the NCR-Fwd access link DL transmission beam. One of the set of candidate beams for the NCR-Fwd access link UL reception beam may be used for the NCR-Fwd access link UL reception beam. It is to be noted that an operation illustrated in FIG. 18 may applied to the above-described C), the above-described D), and the above-described E).

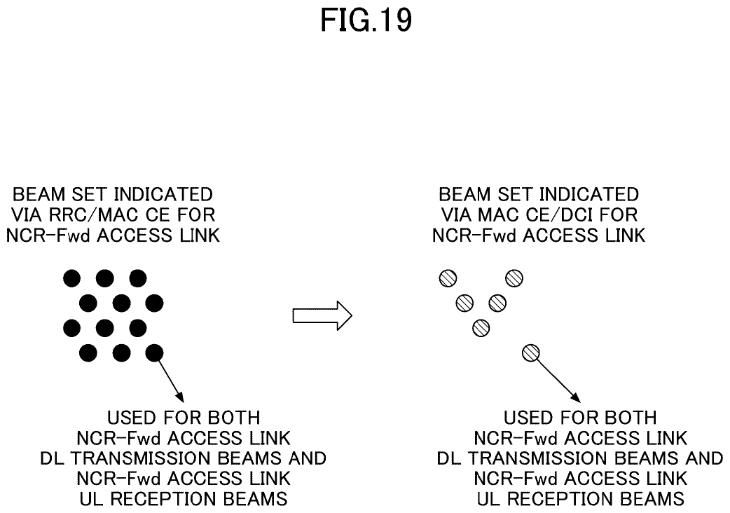

FIG. 19 is a drawing for describing an example (5) of beams used for an access link in an embodiment of the present invention. As illustrated in FIG. 19, the set of candidate beams may be indicated to the NCR 30 in common for the NCR-Fwd access link DL transmission beam and for the NCR Fwd access link UL reception beam via RRC or MAC-CE. One of the set of candidate beams may be used for both the NCR-Fwd access link DL transmission beam and the NCR-Fwd access link UL reception beam.

In addition, some of the beams among the set of candidate beams may be indicated to the NCR 30 as a subset of candidate beams via MAC-CE or DCI. One of the beams among the subset of candidate beams may be used for both the NCR-Fwd access link DL transmission beam and for the NCR-Fwd access link UL reception beam. It is to be noted that all of RRC, MAC-CE, and DCI may be used with respect to the signaling. It is to be noted that an operation illustrated in FIG. 19 may applied to the above described B) and the above described E).

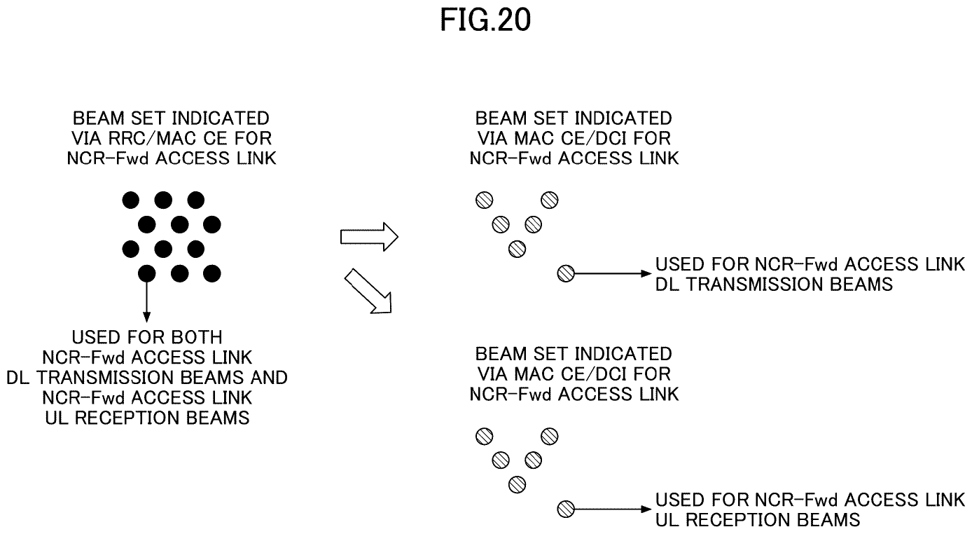

FIG. 20 is a drawing for describing an example (6) of beams used for an access link in an embodiment of the present invention. As illustrated in FIG. 20, the set of candidate beams may be indicated to the NCR 30 in common for the NCR-Fwd access link DL transmission beam and for the NCR Fwd access link UL reception beam via RRC or MAC-CE. One of the set of candidate beams may be used for both the NCR-Fwd access link DL transmission beam and for the NCR-Fwd access link UL reception beam.

In addition, a subset of candidate beams for the NCR-Fwd access link DL transmission beam and a subset of candidate beams for the NCR-Fwd access link UL reception beam may be each separately indicated to the NCR 30 as a part of beams of the set of candidate beams via MAC-CE or DCI. One of the subset of candidate beams for the NCR-Fwd access link DL transmission beam may be used for the NCR-Fwd access link DL transmission beam. One of the subset of candidate beams for the NCR-Fwd access link UL reception beam may be used for the NCR-Fwd access link UL reception beam. It is to be noted that all of RRC, MAC-CE, and DCI may be used with respect to the signaling. It is to be noted that an operation illustrated in FIG. 20 may applied to the above-described B) and the above-described E).

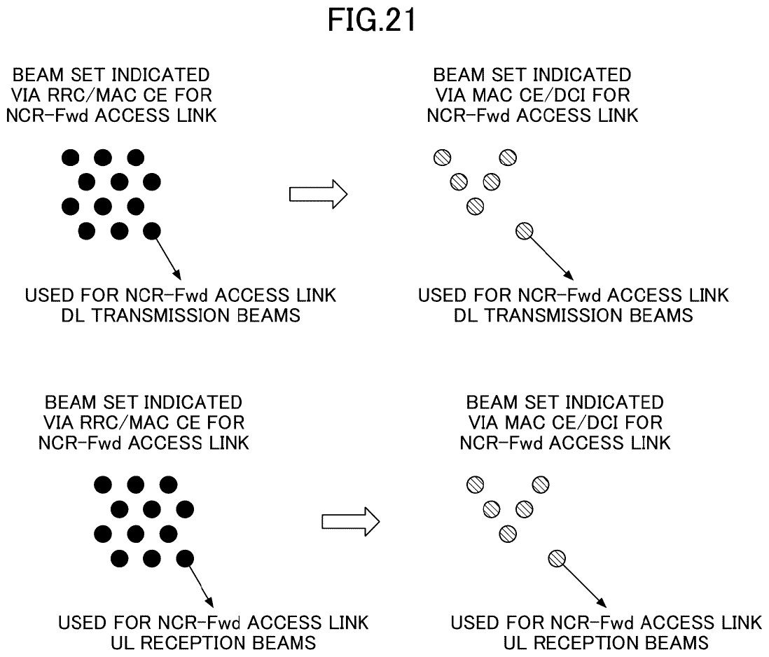

FIG. 21 is a drawing for describing an example (7) of beams used for an access link in an embodiment of the present invention. As illustrated in FIG. 21, a set of candidate beams for the NCR-Fwd access link DL transmission beam and a set of candidate beams for the NCR-Fwd access link UL reception beam may be separately indicated to the NCR 30 via RRC or MAC-CE. One of the set of candidate beams for the NCR-Fwd access link DL transmission beam may be used for the NCR-Fwd access link DL transmission beam. One of the set of candidate beams for the NCR-Fwd access link UL reception beam may be used for the NCR-Fwd access link UL reception beam.

In addition, a part of beams of the set of candidate beams for the NCR-Fwd access link DL transmission beam may be indicated to the NCR 30 as a subset of candidate beams of the NCR-Fwd access link DL transmission via MAC-CE or DCI. A part of beams of the set of candidate beams for the NCR-Fwd access link UL reception beam may be indicated to the NCR 30 as a subset of candidate beams for the NCR-Fwd access link UL reception beam via MAC-CE or DCI. It is to be noted that all of RRC, MAC-CE, and DCI may be used with respect to the signaling. It is to be noted that an operation illustrated in FIG. 21 may applied to the above described B) and the above-described E).

As described above, the index of the NCR-Fwd UL reception beam may a beam index, a source RS index, or a TCI state index.

The index of the NCR-Fwd DL transmission beam may a beam index, a source RS index, or a TCI state index. The source RS may an RS that is newly defined and used for management of the NCR Fwd DL transmission beam. The source RS may be used as a reference for the spatial domain filter of the NCR 30. Each source RS may occupy predetermined time domain resources indicated by the base station 10. The NCR 30 amplifies-and-forwards each source RS from the terminal 20 to the base station 10. In a case where a source RS is indicated as a beam ID for a certain time unit, a DL transmission spatial filter that is the same as that of the indicated source RS may be used.

### <Operation 3>

With respect to the NCR-Fwd beams in the backhaul link, the NCR 30 may expect that the TCI state is to be the same as that of the NCR-MT control link. In a case where the 3GPP release 15/16 beam management is used for the NCR-MT, the TCI state is indicated for each CORESET, for each PDSCH, for each CSI-RS, for each PUCCH resource, for each PUSCH, or for each SRS resource.

Here, in a case where the 3GPP release 15/16 beam management is used for the NCR-MT, a different TCI state is expected to be used by the NCR-MT for a different channel or RS. At this time, which one of the TCI states of the control link of the NCR-MT is applied to the backhaul link of the NCR-Fwd is required to be determined.

The NCR 30 may expect that the TCI state for the NCR-Fwd backhaul link is to be the same as that of the NCR-MT control link. In a case where the unified TCI state of the 3GPP release 17 is used by the NCR-MT, the indicated unified TCI state may be applied to the channel or reference signal as illustrated in Table 1.

TABLE 1

| Channel or | |
|---|---|
| reference | |
| signal | Condition in which “indicated unified TCI state” is applied |
| PDCCH | For CORESET 0, if followUnifiedTCIstate is configured, “indicated |
| | unified TCI state” is applied; if followUnifiedTCIstate is not |
| | configured, the release 15 specification is reused (that is, MAC-CE |
| | activated TCI state or QCLed with SSB) |
| | For CORESET (excluding 0) with only USS and/or CSS type 3, |
| | “indicated unified TCI state” is always applied |
| | For CORESET (excluding 0) with CSS other than CSS type 3, if |
| | followUnifiedTCIstate is configured, “indicated unified TCI state” is |
| | applied; if followUnifiedTCIstate is not configured, configured TCI |
| | state for the CORESET is applied |
| PDSCH | For UE-dedicated PDSCH, “indicated unified TCI state” is always |
| | applied |
| | For non-UE-dedicated PDSCH, if followUnifiedTCIstate is |
| | configured, “indicated unified TCI state” is applied; if |
| | followUnifiedTCIstate is not configured, configured TCI state for the |
| | CORESET is applied |
| CSI-RS | For CSI-RS for CSI acquisition or beam management, if |
| | followUnifiedTCIstate is configured, “indicated unified TCI state” is |
| | applied; for other CSI-RSs, configured TCI state for CSI-RS resource |
| | is applied |
| PUCCH | For dedicated PUCCH, “indicated unified TCI state” is always |
| | applied |
| PUSCH | For dynamic/configured grant PUSCH, “indicated unified TCI state” |
| | is always applied |
| SRS | For A-SRS for beam management or A/SP/P-SRS for Codebook, |
| | Non-codebook, and AntennaSwitching, if followUnifiedTCIstate is |
| | configured for SRS resources, “indicated unified TCI state” is applied |
| | For other SRSs, configured TCI state in the SRS resource is applied |

For example, as illustrated in Table 1, in a case of CORESETO and CORESET for CSS (Common search space) excluding CSS type 3, whether or not to apply the indicated unified TCI state may be configured by an RRC parameter, followUnifiedTCIstate. In a case of other CORESETs, the indicated unified TCI state may be applied.

For example, as illustrated in Table 1, in a case of non-UE-dedicated PDSCH, whether or not to apply the indicated unified TCI state may be configured by an RRC parameter, follow UnifiedTCIstate. In a case of other PDSCHs, the indicated unified TCI state may be applied.

For example, as illustrated in Table 1, in a case of A-CSI-RS (Aperiodic CSI-RS) or beam management, whether or not to apply the indicated unified TCI state may be configured by an RRC parameter, follow UnifiedTCIstate.

For example, as illustrated in Table 1, in a case of PUCCH or PUSCH, the indicated unified TCI state may be always applied.

For example, as illustrated in Table 1, in a case of SRS for beam management, AP (aperiodic)/SP (semi-persistent)/P (periodic)-SRS for codebook, non-codebook, and antenna switching, whether or not to apply the indicated unified TCI state may be configured by an RRC parameter, follow UnifiedTCIstate.

Here, in a case where the 3GPP release 17 unified TCI state framework is used for the NCR-MT, a different TCI state is expected to be used by the NCR-MT for a different channel or RS. At this time, which one of the TCI states of the control link of the NCR-MT is applied to the backhaul link of the NCR-Fwd is required to be determined.

In a case where the time unit is a time unit in which only forwarding an uplink signal from the terminal 20 to the base station 10 is required to be performed, the NCR 30 itself is not required to transmit a UL channel and/or a reference signal. In other words, scheduling of a UL channel and/or a reference signal for the NCR 30 may be unnecessary. In a case where there is no indication of a transmission beam to be transmitted by the NCR 30, the NCR 30 may expect that the uplink transmission beam is to be the latest TCI state and/or spatial relation for a specific uplink reference signal and/or channel of the NCR 30.

The latest TCI state and/or spatial relation indicated for a specific uplink reference signal and/or channel may be, for example, the latest TCI state and/or spatial relation of PUSCH, PUCCH, or SRS, or the latest TCI state and/or spatial relation of the PUCCH resource #0. In addition, the NCR 30 may expect that the 3GPP release 15/16/17 rule for determining the default beam for PUSCH, PUCCH, or SRS is to be reused.

In a case where the time unit is a time unit in which only forwarding a DL signal from the base station 10 to the terminal 20 is required to be performed, the NCR 30 is not required to detect and/or decode the downlink channel and/or reference signal. In other words, scheduling of a downlink channel or a reference signal for the NCR 30 may be unnecessary. In a case where there is no indication of a transmission beam to be transmitted by the base station 10, the NCR 30 may determine the downlink reception beam to be received by the NCR 30 and/or the downlink transmission beam to be transmitted by the NCR 30 by assuming that the transmission beam transmitted by the base station 10 is the latest TCI state indicated for a specific downlink reference signal and/or channel.

The latest TCI state indicated for a specific downlink reference signal and/or channel may be, for example, the latest TCI state for PDSCH, PDCCH, or CSI-RS, or may be the latest TCI state for the CORESET #0. In addition, the NCR 30 may expect that the 3GPP release 15/16/17 rule for determining the default beam for PDSCH, PDCCH, or CSI-RS is to be reused.

When controlling the NCR-Fwd DL reception backhaul link, the framework of the 3GPP release 15/16 beam management may be used for the NCR-MT. With respect to a certain time unit, in a case where the NCR-MT receives a DL channel or RS in the time unit, the TCI state that is used by the NCR-MT when receiving the DL channel or the RS may be used for the NCR-Fwd DL reception backhaul link in the time unit. With respect to the above, the simultaneous performance of NCR-MT DL reception and NCR-Fwd DL reception is assumed to be supported.

In addition, with respect to a certain time unit, in a case where the NCR-MT does not receive a DL channel or RS in the time unit, the TCI state for the NCR-MT may be predefined, and the TCI state for the NCR-MT may be used for the NCR-Fwd DL reception backhaul link in the time unit. With respect to the TCI state for the NCR-MT, the following operations described in 1) to 3) may be performed.
1) The TCI state for the NCR-MT may be determined to be a TCI state with a smallest or largest ID among the TCI states configured by the RRC signaling. Alternatively, the TCI state for the NCR-MT may be determined to be a TCI state with a smallest or largest ID among the TCI states activated by MAC-CE for PDSCH. Alternatively, the TCI state for the NCR-MT may be determined to be a TCI state that is mapped to the largest or smallest TCI codepoint activated by MAC-CE for PDSCH.
2) CORESET, CSI-RS, or SSB for the NCR-MT may be determined and the TCI state for the CORESET, CSI-RS, or SSB may be used. For example, the TCI state corresponding to the smallest or largest CORESET ID, CSI-RS resource ID, or SSB index may be used. For example, the TCI state corresponding to the smallest or largest CORESET ID, CSI-RS resource ID, or SSB index in the latest slot in which CORESET, CSI-RS, or SSB is monitored by the NCR-MT may be used. For example, a TCI state corresponding to CSI-RS or SSB that is identified by the NCR-MT at the time of initial access may be used.
3) PDSCH for the NCR-MT may be determined and the TCI state for the PDSCH may be used. For example, a TCI state for the latest PDSCH received by the NCR-MT may be used.

It is to be noted that the “TCI state” may be replaced with “QCL”, “beam”, “spatial relation”, or “spatial domain filter”.

When controlling the NCR-Fwd UL transmission backhaul link, the framework of the 3GPP release 15/16 beam management may be used for the NCR-MT. With respect to a certain time unit, in a case where the NCR-MT transmits a UL channel or RS in the time unit, the TCI state that is used by the NCR-MT when transmitting the UL channel or the RS may be used for the NCR-Fwd UL transmission backhaul link in the time unit. With respect to the above, the simultaneous performance of NCR-MT UL transmission and NCR-Fwd UL transmission is assumed to be supported.

In addition, with respect to a certain time unit, in a case where the NCR-MT does not transmit a UL channel or RS in the time unit, the TCI state for the NCR-MT may be predefined, and the TCI state for the NCR-MT may be used for the NCR-Fwd UL transmission backhaul link in the time unit. With respect to the TCI state for the NCR-MT, a TCI state for the DL channel or RS of the NCR-MT may be determined, and the TCI state may be applied to the NCR-MT UL transmission backhaul. For example, operations of 1) to 3) described below may be performed.
1) The TCI state for the NCR-MT may be determined to be a TCI state with a smallest or largest ID among the TCI states configured by the RRC signaling. Alternatively, the TCI state for the NCR-MT may be determined to be a TCI state with a smallest or largest ID among the TCI states activated by MAC-CE for PDSCH. Alternatively, the TCI state for the NCR-MT may be determined to be a TCI state that is mapped to the largest or smallest TCI codepoint activated by MAC-CE for PDSCH.
2) CORESET, CSI-RS, or SSB for the NCR-MT may be determined and the TCI state for the CORESET, CSI-RS, or SSB may be used. For example, the TCI state corresponding to the smallest or largest CORESET ID, CSI-RS resource ID, or SSB index may be used. For example, the TCI state corresponding to the smallest or largest CORESET ID, CSI-RS resource ID, or SSB index in the latest slot in which CORESET, CSI-RS, or SSB is monitored by the NCR-MT may be used. For example, a TCI state corresponding to CSI-RS or SSB that is identified by the NCR-MT at the time of initial access may be used.
3) PDSCH for the NCR-MT may be determined and the TCI state for the PDSCH may be used. For example, a TCI state for the latest PDSCH received by the NCR-MT may be used.

In addition, a TCI state for the UL channel or RS of the NCR-MT may be determined, and the TCI state may be applied to the NCR-MT UL transmission backhaul. For example, operations of 4) to 6) described below may be performed.
4) The TCI state for the UL channel or RS of the NCR-MT may be determined according to a certain PUCCH-SpatialRelationinfo or SRS-SpatialRelationinfo. For example, the TCI state may be determined according to PUCCH-SpatialRelationinfo or SRS-SpatialRelationinfo with the largest or smallest ID.
5) A PUCCH resource or SRS resource may be determined. The TCI state for the determined PUCCH resource or SRS resource may be used. For example, the TCI state for the smallest or largest PUCCH resource ID or SRS resource ID may be used. For example, the TCI state for the smallest or largest PUCCH resource ID or SRS resource ID in the latest slot used for transmitting PUCCH or SRS by the NCR-MT.
6) PUSCH for the NCR-MT may be determined and the TCI state for the PUSCH may be used. For example, a TCI state for the latest PUSCH transmitted by the NCR-MT may be used.

It is to be noted that the SRS resource may be limited to an SRS resource with usage configured as codebook, non codebook, beam management, or antenna switching. It is to be noted that the “TCI state” may be replaced with “QCL”, “beam”, “spatial relation”, or “spatial domain filter”.

When controlling the NCR-Fwd DL reception backhaul link, the framework of the 3GPP release 17 unified TCI state may be used for the NCR-MT. With respect to a certain time unit, in a case where the NCR-MT receives a DL channel or RS in the time unit, the TCI state that is used by the NCR-MT when receiving the DL channel or the RS may be used for the NCR-Fwd DL reception backhaul link in the time unit. With respect to the above, the simultaneous performance of NCR-MT DL reception and NCR-Fwd DL reception is assumed to be supported.

In addition, with respect to a certain time unit, in a case where the NCR-MT does not receive a DL channel or RS in the time unit, the indicated unified TCI state may be also used for the NCR-Fwd DL reception backhaul link in the time unit. Alternatively, with respect to the TCI state for the NCR-MT used for the NCR-Fwd DL reception backhaul link in the time unit, operations described in the following 1) to 3) may be performed.
1) The TCI state for the NCR-MT may be determined to be a TCI state with a smallest or largest ID among the TCI states configured by the RRC signaling. Alternatively, the TCI state for the NCR-MT may be determined to be a TCI state with a smallest or largest ID among the TCI states activated by MAC-CE for PDSCH. Alternatively, the TCI state for the NCR-MT may be determined to be a TCI state that is mapped to the largest or smallest TCI codepoint activated by MAC-CE for PDSCH.
2) CORESET, CSI-RS, or SSB for the NCR-MT may be determined and the TCI state for the CORESET, CSI-RS, or SSB may be used. For example, the TCI state corresponding to the smallest or largest CORESET ID, CSI-RS resource ID, or SSB index may be used. For example, the TCI state corresponding to the smallest or largest CORESET ID, CSI-RS resource ID, or SSB index in the latest slot in which CORESET, CSI-RS, or SSB is monitored by the NCR-MT may be used. For example, a TCI state corresponding to CSI-RS or SSB that is identified by the NCR-MT at the time of initial access may be used.
3) PDSCH for the NCR-MT may be determined and the TCI state for the PDSCH may be used. For example, a TCI state for the latest PDSCH received by the NCR-MT may be used.

When controlling the NCR-Fwd UL transmission backhaul link, the framework of the 3GPP release 17 unified TCI state may be used for the NCR-MT. With respect to a certain time unit, in a case where the NCR-MT transmits a UL channel or RS in the time unit, the TCI state that is used by the NCR-MT when transmitting the UL channel or the RS may be used for the NCR-Fwd UL transmission backhaul link in the time unit. With respect to the above, the simultaneous performance of NCR-MT UL transmission and NCR-Fwd UL transmission is assumed to be supported.

In addition, with respect to a certain time unit, in a case where the NCR-MT does not transmit a UL channel or RS in the time unit, the indicated unified TCI state may be also used for the NCR-Fwd UL transmission backhaul link in the time unit. Alternatively, with respect to the TCI state for the NCR-MT used for the NCR-Fwd UL transmission backhaul link in the time unit, operations described in the following 1) to 3) may be performed.
1) The TCI state for the NCR MT may be determined to be a TCI state with a smallest or largest ID among the TCI states configured by the RRC signaling. Alternatively, the TCI state for the NCR-MT may be determined to be a TCI state with a smallest or largest ID among the TCI states activated by MAC-CE for PDSCH. Alternatively, the TCI state for the NCR-MT may be determined to be a TCI state that is mapped to the largest or smallest TCI codepoint activated by MAC-CE for PDSCH.
2) CORESET, CSI-RS, or SSB for the NCR-MT may be determined and the TCI state for the CORESET, CSI-RS, or SSB may be used. For example, the TCI state corresponding to the smallest or largest CORESET ID, CSI-RS resource ID, or SSB index may be used. For example, the TCI state corresponding to the smallest or largest CORESET ID, CSI-RS resource ID, or SSB index in the latest slot in which CORESET, CSI-RS, or SSB is monitored by the NCR-MT may be used. For example, a TCI state corresponding to CSI-RS or SSB that is identified by the NCR-MT at the time of initial access may be used.
3) PDSCH for the NCR-MT may be determined and the TCI state for the PDSCH may be used. For example, a TCI state for the latest PDSCH received by the NCR-MT may be used.

In addition, a TCI state for the UL channel or RS of the NCR-MT may be determined, and the TCI state may be applied to the NCR-MT UL transmission backhaul. For example, operations of 4) to 6) described below may be performed.
4) The TCI state for the UL channel or RS of the NCR MT may be determined according to a certain PUCCH-SpatialRelationinfo or SRS-SpatialRelationinfo. For example, the TCI state may be determined according to PUCCH-SpatialRelationinfo or SRS-SpatialRelationinfo with the largest or smallest ID.
5) A PUCCH resource or SRS resource may be determined. The TCI state for the determined PUCCH resource or SRS resource may be used. For example, the TCI state for the smallest or largest PUCCH resource ID or SRS resource ID may be used. For example, the TCI state for the smallest or largest PUCCH resource ID or SRS resource ID in the latest slot used for transmitting PUCCH or SRS by the NCR-MT.
6) PUSCH for the NCR-MT may be determined and the TCI state for the PUSCH may be used. For example, a TCI state for the latest PUSCH transmitted by the NCR-MT may be used.

It is to be noted that the “TCI state” may be replaced with “QCL”, “beam”, “spatial relation”, or “spatial domain filter”,

According to an embodiment of the present invention, the network. controlled repeater can apply a UL reception beam and a DL transmission beam to wireless signals that are relayed by the NCR-Fwd in the access link, based on the control from the network. In addition, the network-controlled repeater can apply a DL reception beam and a UL transmission beam to wireless signals that are relayed by the NCR-Fwd in the backhaul link, based on the control from the network.

In other words, wireless signals can be relayed by the network. controlled wireless relay device in the wireless communication system.

### (Hardware Structure)

In the above block diagrams used for describing an embodiment of the present invention (FIG. 2, FIG. 3, and FIG. 4), functional unit blocks are shown. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include, but are not limited to, judging, determining, calculating, processing, deriving, investigating, searching, checking, receiving, transmitting, outputting, accessing, resolving, selecting, establishing, comparing, assuming, expecting, and deeming, broadcasting, notifying, communicating, forwarding, configuring, reconfiguring, allocating, mapping, and assigning, etc. For example, a functional block (component) that functions to perform transmission is called a transmitting unit or a transmitter. The method for implementing each component is not particularly limited as described above.

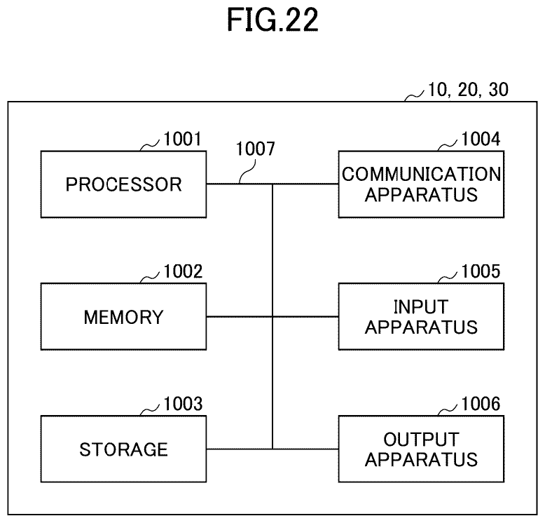

For example, the base station 10, the terminal 20, and the wireless relay device 30, etc., according to an embodiment of the present invention may function as a computer for processing the wireless communication method of the present disclosure. FIG. 22 is a drawing illustrating an example of hardware structures of the base station 10, the terminal 20 and the wireless relay device 30 according to an embodiment of the present invention. Each of the above-described base station 10, the terminal 20, and the wireless relay device 30 may be a computer device including a processor 1001, a memory 1002, a storage 1003, a communication apparatus 1004, an input apparatus 1005, an output apparatus 1006, a bus 1007, etc.

Note that in the present disclosure, the words such as an apparatus, a circuit, a device, a section, a unit, and so on can be interchangeably interpreted. The hardware structures of the base station 10, the terminal 20 and the wireless relay device 30 may include one or more of each of the devices illustrated in the figure, or may be configured without including some of the devices.

Each function in the base station 10, the terminal 20 and the wireless relay device 30 is implemented by having the processor 1001 perform an operation by reading predetermined software (programs) onto hardware such as the processor 1001 and the memory 1002, and by controlling communication by the communication apparatus 1004 and controlling at least one of reading or writing of data in the memory 1002 and the storage 1003.

The processor 1001 controls the whole computer by, for example, running an operating system. The processor 1001 may include a central processing unit (CPU) including an interface with a peripheral apparatus, a control apparatus, a calculation apparatus, a register, etc. For example, the above described control unit 140, control unit 240, and so on may be implemented by the processor 1001.

Furthermore, the processor 1001 reads programs (program codes), software modules, data, or the like, from at least one of the storage 1003 and the communication apparatus 1004, into the memory 1002, and executes various processes according to these. As for the programs, programs to allow computers to execute at least part of the operations of the above-described embodiments are used. For example, the control unit 140 of the base station 10 illustrated in FIG. 2 may be implemented by control programs that are stored in the memory 1002 and that operate on the processor 1001. In addition, for example, the control unit 240 of the terminal 20 illustrated in FIG. 3 may be implemented by control programs that are stored in the memory 1002 and that operate on the processor 1001. The various processes have been described to be performed by a single processor 1001, However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The memory 1002 may be referred to as a “register,” a “cache,” a “main memory (primary storage apparatus)” and so on. The memory 1002 can store executable programs (program codes), software modules, and the like for implementing the communication method according to one embodiment of the present disclosure.

The storage 1003 is a computer-readable recording medium, and may include at least one of, for example, an optical disk such as a CD-ROM (Compact Disc ROM), a hard disk drive, a flexible disk, a magneto optical disk (e.g., compact disk, digital versatile disk, Blu-ray (registered trademark) disk), a smart card, a flash memory (e.g., card, stick, key drive), a floppy (registered trademark) disk, a magnetic strip, etc. The above recording medium may be a database including the memory 1002 and/or the storage 1003, a server, or any other appropriate medium.

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may include a high frequency switch, duplexer, filter, frequency synthesizer, or the like, for example, to implement at least one of a frequency division duplex (FDD) and a time division duplex (TDD). For example, the transmitting/receiving antenna, the amplifier unit, the transmitting/receiving unit, the transmission line interface, and the like, may be implemented by the communication apparatus 1004. The transmitting/receiving unit may be physically or logically divided into a transmitting unit and a receiving unit.

The input apparatus 1006 is an input device that receives input from the outside (for example, a keyboard, a mouse, a microphone, a switch, a button, a sensor, and so on). The output apparatus 1006 is an output device that outputs something to the outside (e.g., display, speaker, LED lamp). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Further, each of the base station 10, the terminal 20 and the wireless relay device 30 may include hardware such as a microprocessor, a digital signal processor (DSP), an ASIC (Application Specific Integrated Circuit), a PLD (Programmable Logic Device), an FPGA (Field Programmable Gate Array), etc., and a part or all of each functional block may be implemented by the hardware. For example, the processor 1001 may be implemented with at least one of these pieces of hardware.

In addition, the wireless relay device 30 may include a variable phase shifter, phase shifter, amplifier, antenna, antenna array, or the like, as the hardware included in the variable unit 340 and the antenna unit 350 depending on the necessity.

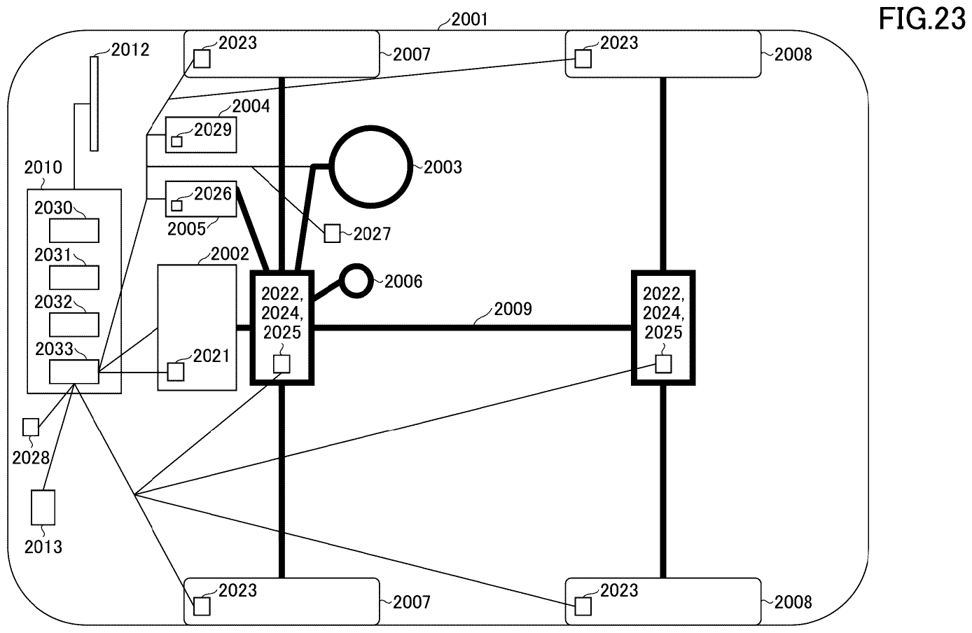

FIG. 23 shows an example of a configuration of a vehicle 2001. As shown in FIG. 23, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021-2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like. The information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside,

A driving support system unit 2030 includes: various devices for providing functions of preventing accidents and reducing driver's operating loads such as a millimeter wave radar, a LIDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2029 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 may transmit, to an external device by using wireless communications, at least one of: a signal from the above-described various sensors 2021 to 2028 that is input to the electronic control unit 2010; information that is obtained based on the signal; or information based on an input obtained from outside (user) via the information service unit 2012. The electronic control unit 2010, the various sensors 2021 to 2028, the information service unit 2012, or the like, may be referred to as an input unit for receiving an input. For example, the PUSCH transmitted by the communication module 2013 may include information based on the input.

The communication module 2013 receives various types of information (traffic information, signal information, inter-vehicle information, etc.) transmitted from the external devices and displays the received information on the information service unit 2012 provided in the vehicle 2001. The information service unit 2012 may be referred to as an output unit that outputs information (for example, outputs information to devices, such as a display and a speaker, based on the PDSCH received by the communication module 2013 (or data/information decoded from the PDSCH)). In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in the vehicle 2001.

### Embodiment Summary

As described above, according to an embodiment of the present invention, a wireless relay device is provided. The wireless relay device includes: a communication unit configured to perform transmission and reception of signaling including control information related to a relay function to and from a base station; a control unit configured to control the relay function based on the control information; and a relay unit configured to perform the relay function of receiving an uplink signal from a terminal and transmitting the uplink signal to the base station, and of receiving a downlink signal from the base station and transmitting the downlink signal to the terminal. The control unit determines an uplink reception beam that is applied to reception of the uplink signal, an uplink transmission beam that is applied to transmission of the uplink signal, a downlink reception beam that is applied to reception of the downlink signal, and a downlink transmission beam that is applied to transmission of the downlink signal, based on the control information.

According to the above-described configuration, the network-controlled repeater can apply a UL reception beam and a DL transmission beam to wireless signals that are relayed by the NCR-Fwd in the access link, based on the control from the network. In addition, the network-controlled repeater can apply a DL reception beam and a UL transmission beam to wireless signals that are relayed by the NCR-Fwd in the backhaul link, based on the control from the network. In other words, wireless signals can be relayed by the network controlled wireless relay device in the wireless communication system.

The communication unit may transmit, to the base station, information indicating a set of beam candidates to be applied to the downlink transmission beam and the uplink reception beam, and may receive information indicating beams to be used among the set of beam candidates from the base station. According to the above-described configuration, the network controlled repeater can apply a UL reception beam and a DL transmission beam to wireless signals that are relayed by the NCR-Fwd in the access link, based on the control from the network.

The communication unit may receive first control information indicating a set of beam candidates to be applied to the downlink transmission beam and the uplink reception beam, may receive second control information indicating a subset of beam candidates to be applied to the downlink transmission beam among the set of beam candidates, and may receive third control information indicating a subset of beam candidates to be applied to the uplink reception beam among the set of beam candidates. According to the above-described configuration, the network-controlled repeater can apply a UL reception beam and a DL transmission beam to wireless signals that are relayed by the NCR-Fwd in the access link, based on the control from the network.

The control unit may determine that the downlink reception beam and the uplink transmission beam in a certain time unit are beams that are applied to the signaling transmitted and received in the time unit. According to the above-described configuration, the network controlled repeater can apply a DL reception beam and a UL transmission beam to wireless signals that are relayed by the NCR-Fwd in the backhaul link, based on the control from the network.

In a case where the signaling is not transmitted and received in a certain time unit, the control unit may determine the downlink reception beam and the uplink transmission beam in the time unit, based on a TCI (Transmission Configuration Indication) state that is applied to a most recent channel carrying the signaling. According to the above-described configuration, the network-controlled repeater can apply a DL reception beam and a UL transmission beam to wireless signals that are relayed by the NCR Fwd in the backhaul link, based on the control from the network.

In addition, according to an embodiment of the present invention, a communication method performed by a wireless relay device is provided. The communication method includes: performing transmission and reception of signaling including control information related to a relay function to and from a base station; controlling the relay function based on the control information; performing the relay function of receiving an uplink signal from a terminal and transmitting the uplink signal to the base station, and of receiving a downlink signal from the base station and transmitting the downlink signal to the terminal; and determining an uplink reception beam that is applied to reception of the uplink signal, an uplink transmission beam that is applied to transmission of the uplink signal, a downlink reception beam that is applied to reception of the downlink signal, and a downlink transmission beam that is applied to transmission of the downlink signal, based on the control information.

According to the above described configuration, the network controlled repeater can apply a UL reception beam and a DL transmission beam to wireless signals that are relayed by the NCR-Fwd in the access link, based on the control from the network. In addition, the network-controlled repeater can apply a DL reception beam and a UL transmission beam to wireless signals that are relayed by the NCR-Fwd in the backhaul link, based on the control from the network. In other words, wireless signals can be relayed by the network controlled wireless relay device in the wireless communication system.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

In addition, notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling), and other signals or combinations of these. Also, RRC signaling may be referred to as an “RRC message,” and can be, for example, an RRC connection setup message, an RRC connection reconfiguration message, and so on.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods, next generation systems that are enhanced, modified, created, or defined based on these, and the like. A plurality of systems may be combined (for example, a combination of LTE or LTE-A and 5G, and the like) for application.

The order of processes, sequences, flowcharts, and so on that have been used to describe the aspects/embodiments in the present specification may be re-ordered as long as inconsistencies do not arise. For example, although various methods have been illustrated in the present disclosure with various components of steps in exemplary orders, the specific orders that are illustrated herein are by no means limiting.

Operations which have been described in the present specification to be performed by a base station 10 may, in some cases, be performed by an upper node of the base station 10. In a network including one or a plurality of network nodes with base stations 10, it is clear that various operations that are performed to communicate with terminals 20 can be performed by base stations 10, one or more network nodes (for example, Mobility Management Entities (MMEs), Serving-Gateways (S-GWs), and so on may be possible, but these are not limiting) other than base stations 10, or combinations of these. According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on,

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on. The mobile station is an object that can move, and the moving speed can be any speed. In addition, a mobile station that is not moving is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of the base station and the mobile station may be an IoT (Internet of Things) device such as a sensor.

Furthermore, the base station in the present disclosure may be interpreted as a user terminal. For example, each aspect/embodiment of the present disclosure may be applied to the structure that replaces a communication between a base station and a user terminal with a communication between a plurality of terminals 20 (for example, which may be referred to as “Device-to-Device (D2D),” “Vehicle-to-Everything (V2X),” and the like). In this case, terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station may have the functions of the user terminal described above.

As used herein, the term “determining” may encompasses a wide variety of actions. For example, “determining” may be regarded as judging, calculating, computing, processing, deriving, investigating, looking up (search, inquiry) (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing, and the like. That is, “determining” may be regarded as a certain type of action related to determining. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), number of symbols per TTI, radio frame configuration, specific filtering processing performed by the transceiver in the frequency domain, and specific windowing processing performed by the transceiver in the time domain.

The slot may include one or more symbols in the time domain (OFDM (Orthogonal Frequency Division Multiplexing) symbols, SC-FDMA (Single Carrier Frequency Division Multiple Access) symbols, and the like). Furthermore, a slot may be a time unit based on numerology.

A slot may include a plurality of mini-slots. Each mini slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a transmission time interval (TTI), multiple consecutive subframes may be referred to as a TTI, and one slot or one mini slot may be referred to as a TTI. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for terminals 20, scheduling of allocating radio resources (such as a frequency bandwidth and transmit power available for each terminal 20) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length, One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG), “a “PRB pair,” an “RB pair” and so on.

Furthermore, a resource block may be constituted of one or a plurality of resource elements (Res). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a terminal 20.

At least one of configured BWPs may be active, and a terminal 20 may not need to assume to transmit/receive a certain signal/channel outside the active BWP(s). Note that a “cell,” a “carrier,” and so on in the present disclosure may be interpreted as a “BWP”.

Note that the above described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini slot, the number of subcarriers included in an RB, the number of symbols in a TTI, the symbol length, the cyclic prefix (CP) length, and so on can be variously changed.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”,

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

It is to be noted that, in the present disclosure, the variable unit 340 and the antenna unit 350 are examples of a relay unit.

As described above, the present invention has been described in detail. It is apparent to a person skilled in the art that the present invention is not limited to one or more embodiments of the present invention described in the present specification, Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
30 Wireless relay device
310 Transmission unit
320 Reception unit
330 Control unit
340 Variable unit
350 Antenna unit
1001 Processor
1002 Memory
1003 Storage
1004 Communication apparatus
1005 Input apparatus
1006 Output apparatus
2001 Vehicle
2002 Drive unit
2003 Steering unit
2004 Accelerator pedal
2005 Brake pedal
2006 Shift lever
2007 Front wheel
2008 Rear wheel
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port (IO port)

1. A wireless relay device comprising:
a communication unit configured to perform transmission and reception of signaling including control information related to a relay function to and from a base station;
a control unit configured to control the relay function based on the control information; and
a relay unit configured to perform the relay function of receiving an uplink signal from a terminal and transmitting the uplink signal to the base station, and of receiving a downlink signal from the base station and transmitting the downlink signal to the terminal, wherein
the control unit determines an uplink reception beam that is applied to reception of the uplink signal, an uplink transmission beam that is applied to transmission of the uplink signal, a downlink reception beam that is applied to reception of the downlink signal, and a downlink transmission beam that is applied to transmission of the downlink signal, based on the control information.

2. The wireless relay device as claimed in claim 1, wherein
the communication unit transmits, to the base station, information indicating a set of beam candidates to be applied to the uplink transmission beam and the uplink reception beam, and receives information indicating beams to be used among the set of beam candidates from the base station.

3. The wireless relay device as claimed in claim 1, wherein
the communication unit receives first control information indicating a set of beam candidates to be applied to the downlink transmission beam and the uplink reception beam, receives second control information indicating a subset of beam candidates to be applied to the downlink transmission beam among the set of beam candidates, and receives third control information indicating a subset of beam candidates to be applied to the uplink reception beam among the set of beam candidates.

4. The wireless relay device as claimed in claim 1, wherein
the control unit determines that the downlink reception beam and the uplink transmission beam in a certain time unit are beams that are applied to the signaling transmitted and received in the time unit.

5. The wireless relay device as claimed in claim 1, wherein
in a case where the signaling is not transmitted and received in a certain time unit, the control unit determines the downlink reception beam and the uplink transmission beam in the time unit, based on a TCI (Transmission Configuration Indication) state that is applied to a most recent channel carrying the signaling.

6. A communication method performed by a wireless relay device, the communication method comprising:
performing transmission and reception of signaling including control information related to a relay function to and from a base station;
controlling the relay function based on the control information;
performing the relay function of receiving an uplink signal from a terminal and transmitting the uplink signal to the base station, and of receiving a downlink signal from the base station and transmitting the downlink signal to the terminal; and
determining an uplink reception beam that is applied to reception of the uplink signal, an uplink transmission beam that is applied to transmission of the uplink signal, a downlink reception beam that is applied to reception of the downlink signal, and a downlink transmission beam that is applied to transmission of the downlink signal, based on the control information.
